(19) United States
(12) Patent Application Publication
(10) Pub. No.: US 2007/0285456 A1
(43) Pub. Date: Dec. 13, 2007

(54) INK JET RECORDING APPARATUS

(75) Inventors: Takuma TAKASU, Fukuoka (JP); Shigeyuki TAKAO, Fukuoka (JP); Hideaki HORIO, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/759,370

(22) Filed: Jun. 7, 2007

(30) Foreign Application Priority Data
Jun. 9, 2006 (JP) 2006-160492
Jun. 14, 2006 (JP) 2006-164307
Aug. 9, 2006 (JP) 2006-216889

(51) Int. Cl. B41J 29/393

(52) U.S. Cl. 347/19

(57) ABSTRACT

There are provided a recording head for ejecting a liquid droplet from a nozzle based on an ejecting signal to form a pattern on a recording medium, a humidity detecting portion for detecting an absolute humidity in the vicinity of the nozzle, a humidifier for humidifying the vicinity of the nozzle, and a humidifying portion driving control portion (control board) for controlling the humidifier based on the absolute humidity detected by the humidity detecting portion.

### BACKGROUND OF THE INVENTION

1. Field of the Invention

The present invention relates to an ink jet recording apparatus having a recording head for ejecting a liquid droplet from a nozzle based on an ejecting signal to form a pattern constituted by a liquid droplet on a recording medium, and more particularly to a humidifier for humidifying the vicinity of the nozzle of the ink jet recording apparatus.

2. Description of the Related Art

In a recording apparatus for ejecting an aqueous liquid having a drying property, conventionally, an opening portion of a nozzle in a recording head is usually closed by capping so that moisture drying from the opening portion of the nozzle is suppressed when the recording apparatus is not operated, and the opening portion of the nozzle is always exposed to prepare for a liquid ejecting operation when the recording apparatus is operated. For this reason, the liquid of the nozzle which is not ejected is easily dried in a low humidity environment. In the case in which a recording time is prolonged, particularly, a viscosity of the liquid in the opening portion of the nozzle is increased. As a result, an amount of the liquid droplet which is ejected is insufficient or nozzle clogging is caused so that there is a problem in that recording picture quality is deteriorated.

In order to solve the problem, there has conventionally been proposed a recording apparatus having a structure in which a humidifier is provided and humidified air is supplied to the vicinity of a nozzle of a recording head (for example, see JP-A-2000-255053 Publication and JP-A-2000-79696 Publication). Consequently, a liquid can be prevented from being dried in the vicinity of the nozzle.

According to the related art, however, there is not a clear operating condition of the humidifier capable of suppressing an increase in a viscosity of a liquid due to a dryness of a water solvent on a liquid meniscus surface of an opening portion of a nozzle and preventing an insufficient amount of a liquid droplet which is ejected and nozzle clogging. For this reason, there is a drawback that a timing for operating the recording apparatus in the operation of the humidifier cannot be decided. Moreover, there is not a clear humidifying condition corresponding to the physical properties of a liquid for stably forming the liquid meniscus of the opening portion of the nozzle and carrying out a recording operation of high picture quality without flight bending or scattering of the liquid droplet.

### SUMMARY OF THE INVENTION

In consideration of the foregoing, it is an object of the invention to provide an ink jet recording apparatus capable of preventing an insufficient amount of liquid droplets and nozzle clogging, thereby achieving a recording operation of high picture quality.

In order to solve the problems, the invention provides an ink jet recording apparatus comprising a recording head for ejecting a liquid droplet from a nozzle based on an ejecting signal to form a pattern on a recording medium, a humidity detecting portion for detecting an absolute humidity in the vicinity of the nozzle, a humidifying portion for humidifying the vicinity of the nozzle, and a humidifying portion driving control portion for controlling the humidifying portion based on the absolute humidity detected by the humidity detecting portion.

According to the invention, it is possible to obtain an ink jet recording apparatus capable of carrying out a recording operation of high picture quality.

### BRIEF DESCRIPTION OF THE DRAWINGS

FIG. 1 is a view showing an example of a schematic structure of an ink jet recording apparatus having a recording head of a serial head type according to a first embodiment of the invention,

FIG. 2 is an explanatory view showing a part of a bottom face of the recording head according to the first embodiment of the invention,

FIG. 3 is a sectional view showing the recording head according to the first embodiment of the invention,

FIG. 4 is a sectional view showing the recording head according to the first embodiment of the invention,

FIG. 5 is a view showing an example of a schematic structure of an ink jet recording apparatus having a recording head of a line head type according to the first embodiment of the invention,

FIGS. 6A, 6B, 6C and 6D are graphs showing an air humidity dependency in the vicinity of a nozzle for ejecting liquid droplets according to the first embodiment of the invention,

FIG. 7 is an explanatory view typically showing an insufficient state of an amount of ejection of the liquid droplets in the recording head according to the first embodiment of the invention,

FIG. 8 is an explanatory view typically showing a nozzle clogging state of the liquid droplets in the recording head according to the first embodiment of the invention,

FIG. 9 is a graph showing a result obtained by measuring a viscosity dependency of an aqueous liquid according to the first embodiment of the invention,

FIG. 10 is an explanatory view typically showing a state in which the liquid droplets ejected from the recording head cause flight bending according to the first embodiment of the invention,

FIG. 11 is an explanatory view typically showing a state in which the liquid droplets ejected from the recording head cause scattering according to the first embodiment of the invention,

FIG. 12 is a view showing a schematic structure of an ink jet recording apparatus having a recording head of a serial head type according to a second embodiment of the invention,

FIG. 13 is a characteristic chart showing a relationship between a vapor content of liquid solvent vapor in the vicinity of a nozzle and a normal ejecting nozzle ratio according to the second embodiment of the invention,

FIG. 14 is a view for explaining a solvent vapor equilibrium layer of a liquid meniscus surface of an opening portion of the nozzle according to the second embodiment of the invention,

FIG. 15 is a view showing a structure according to a variant of the second embodiment in accordance with the invention,

FIG. 16 is a typical sectional view showing an ink jet recording apparatus according to a third embodiment of the invention,

FIG. 17 is an explanatory view showing a state in which a charger is attached according to the third embodiment of the invention,

FIG. 18 is a view showing an array of a line type head of the ink jet recording apparatus according to the third embodiment of the invention,

FIG. 19 is a perspective view showing a main part of a single head according to the third embodiment of the invention,

FIG. 20 is a plan view showing the main part of the single head according to the third embodiment of the invention,

FIG. 21 is a longitudinal sectional view taken along A-A in FIG. 20 according to the third embodiment of the invention,

FIG. 22 is a continuously typical sectional view showing an ink droplet ejecting process of the ink jet recording apparatus according to the third embodiment of the invention,

FIG. 23 is a perspective view showing a main part of a single head according to a fourth embodiment of the invention,

FIG. 24 is a plan view showing the main part of the single head according to the fourth embodiment of the invention,

FIG. 25 is a longitudinal sectional view taken along B-B in FIG. 24 according to the fourth embodiment of the invention,

FIG. 26 is a continuously typical sectional view showing an ink droplet ejecting process of the ink jet recording apparatus according to the fourth embodiment of the invention,

FIG. 27 is a typical sectional view showing an ink jet recording apparatus according to a fifth embodiment of the invention,

FIG. 28 is a perspective view showing a main part of a recording medium charger according to the fifth embodiment of the invention,

FIG. 29 is a longitudinal sectional view showing a main part of a single head according to a sixth embodiment of the invention,

FIG. 30 is a voltage waveform diagram showing an ink jet recording apparatus according to a sixth embodiment of the invention, and

FIG. 31 is a continuously typical sectional view showing an ink droplet ejecting process of the ink jet recording apparatus according to the sixth embodiment of the invention.

### DETAILED DESCRIPTION OF THE PREFERRED EMBODIMENTS

Embodiments according to the invention will be described below.

### First Embodiment

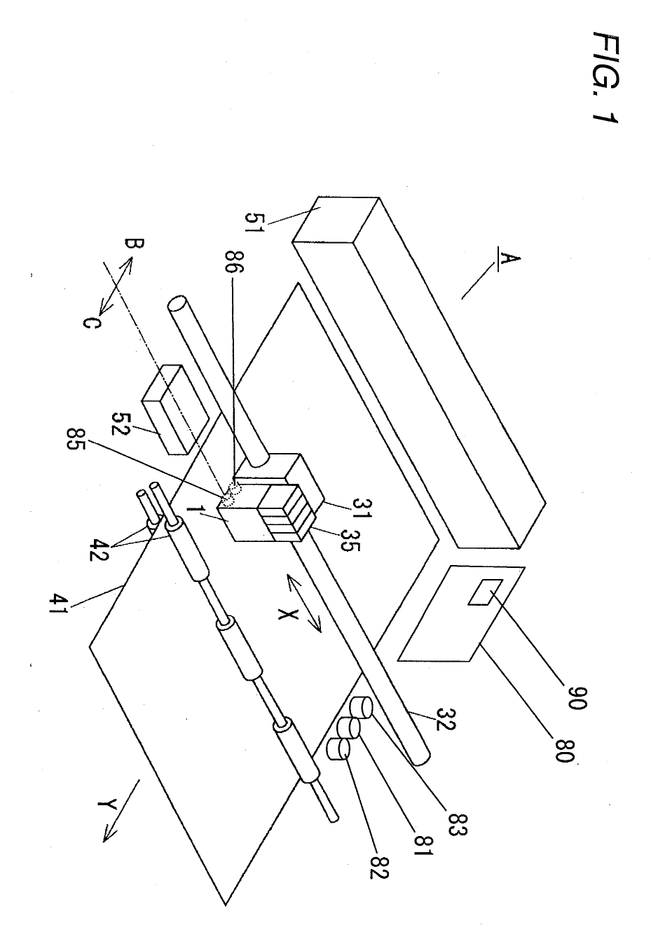

FIG. 1 is a view showing an example of a schematic structure of an ink jet recording apparatus having a recording head of a serial head type according to a first embodiment of the invention.

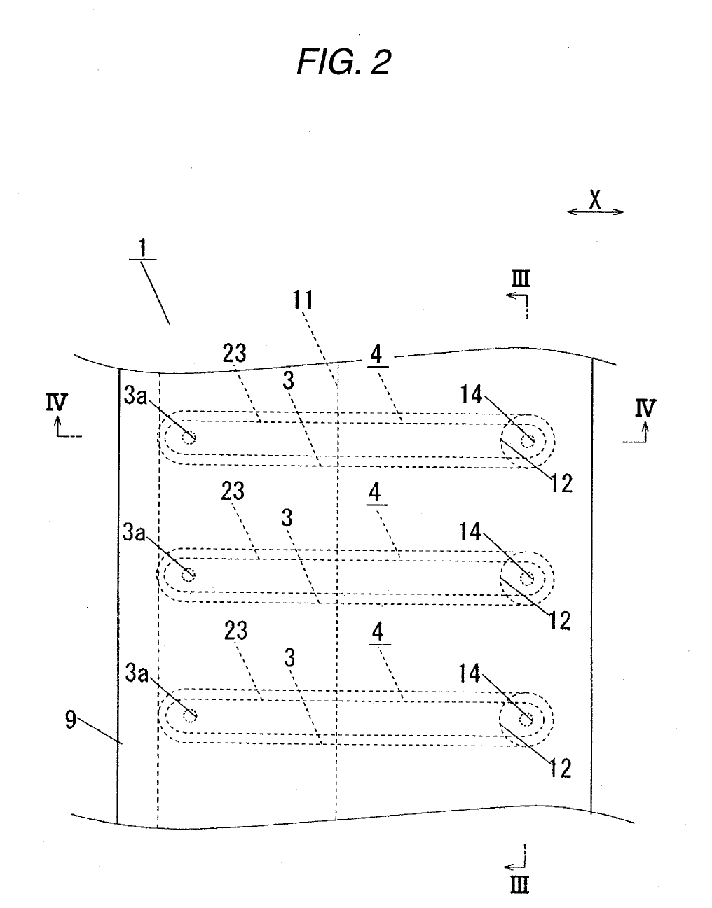

FIG. 2 is an explanatory view showing a part of a bottom face of the recording head according to the first embodiment of the invention.

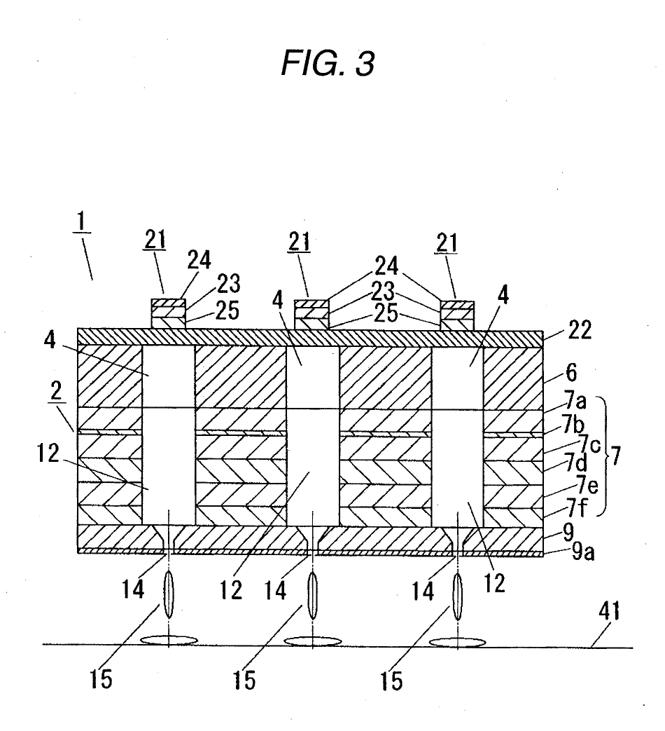

FIG. 3 is a sectional view showing the recording head according to the first embodiment of the invention, illustrating an III-III section in FIG. 2.

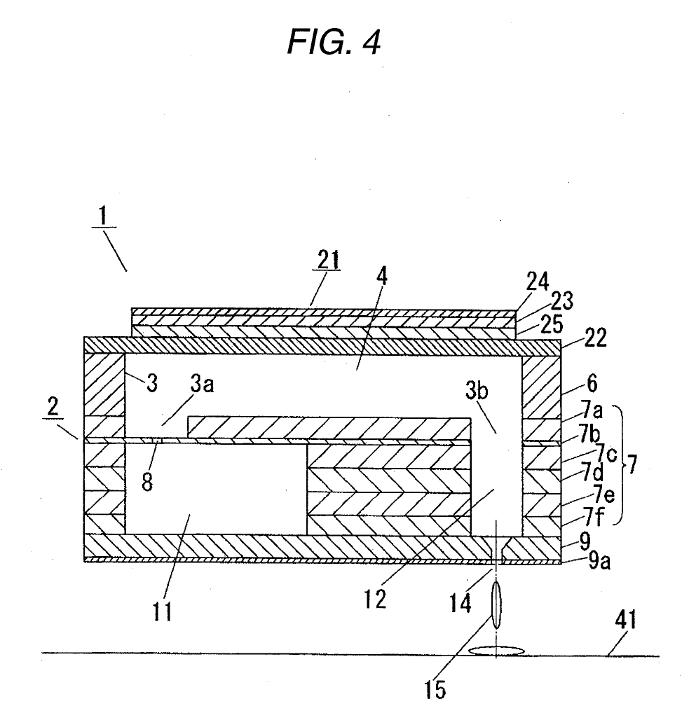

FIG. 4 is a sectional view showing the recording head according to the first embodiment of the invention, illustrating an IV-IV section in FIG. 2.

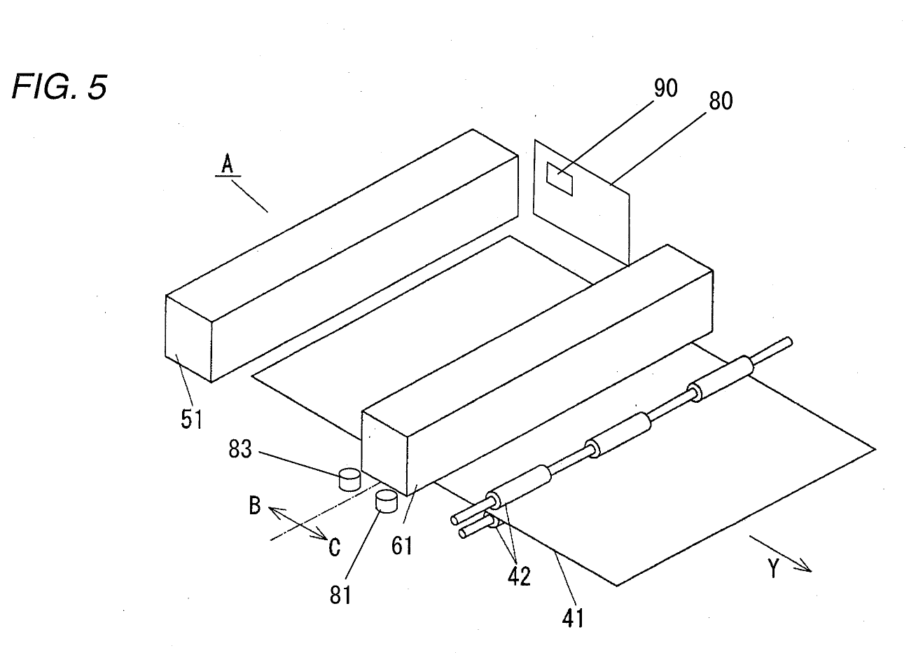

FIG. 5 is a view showing an example of a schematic structure of an ink jet recording apparatus having a recording head of a line head type according to the first embodiment of the invention.

In FIG. 1, A denotes a recording apparatus, 1 denotes a recording head, 31 denotes a carriage, 32 denotes a carriage shaft, 35 denotes a liquid cartridge, 41 denotes a recording medium, for example, a recording paper, 42 denotes a delivery roller, 51 denotes a humidifier constituting a humidifying portion, and 52 denotes a liquid ejecting portion.

The ink jet recording apparatus A having the recording head of the serial head type shown in FIG. 1 (which will be hereinafter referred to as a “recording apparatus A”) comprises the recording head 1 having an upper surface to which the liquid cartridge 35 having a liquid is attached, and the recording head 1 ejects a liquid to the recording medium 41 to be a recording medium as will be described below. Moreover, the recording head 1 has a structure of the serial head type and is supported and fixed onto the carriage 31, and the carriage 31 is supported on the carriage shaft 32 extended in a primary scanning direction (an X direction shown in FIGS. 1 and 2). The carriage 31 has such a structure that the recording head 1 and the carriage 31 are guided by the carriage shaft 32 and can be reciprocated in the primary scanning direction X by means of a carriage motor (not shown) through a power transmitting system (not shown).

Moreover, the liquid ejecting portion 52 for carrying out the flushing ejection of a liquid passage and a nozzle opening portion in the recording head 1 is provided in a position in which the recording medium 41 is not disposed on a track along the carriage shaft 32 through which the recording head 1 is moved. The flushing ejection is carried out by moving the recording head 1 to a region in which the liquid ejecting portion 52 is disposed. In a normal image formation, therefore, it is possible to continuously perform the recording operation without contaminating the recording medium 41 at all.

The recording medium 41 is interposed between two delivery rollers 42 to be rotated and driven by a delivery motor which is not shown. The recording medium 41 is delivered in a secondary scanning direction (a Y direction shown in FIG. 1) which is perpendicular to the primary scanning direction X on a lower side of the recording head 1.

A liquid to be used in the recording apparatus A contains a water soluble dye to be a coloring agent (or an organic pigment or an inorganic pigment may be used), a humectant for suppressing drying through a nozzle 14 of the recording head 1 (see FIG. 2), and water. Since the liquid contains the water and the humectant, a moisture content efficiency of the liquid can be enhanced by using the humidifier 51 and a liquid solvent component can be prevented from being dried so that thickening of the liquid can be prevented. Moreover, it is also possible to contain a penetrating agent for enhancing a permeability into the recording medium 41.

Any dye may be used for the liquid, and an aqueous acid dye or a direct dye is preferable. The humectant is desirably polyhydric alcohol such as glycerin or an aqueous nitrogen heterocyclic compound such as 2-pyrolidone or N-methyl-2-pyrolidone. Moreover, the penetrating agent is preferably monoalkyl ether to be the polyhydric alcohol, for example, diethyleneglycol monobutyl ether (hereinafter referred to as DEGMBE). The penetrating agent is not essential to a creation of the liquid and can also be omitted.

In FIG. 5 showing a schematic structure of a recording apparatus A having a recording head 60 of a line head type, moreover, A denotes a recording apparatus, 1 denotes a recording head, 41 denotes a recording medium such as a recording paper, 42 denotes a delivery roller, and 51 denotes a humidifier constituting a humidifying portion.

The recording apparatus A having the recording head 60 of the line head type shown in FIG. 5 comprises the recording head 60 having such a structure as to include a liquid cartridge having a liquid and to have a dimension which is equal to or greater than a width of the recording medium 41 (a dimension in a perpendicular direction to a secondary scanning direction (a Y direction shown in FIG. 5)), and to be extended in the secondary scanning direction Y. Since the recording head 60 of the line head type is disposed wholly in a direction of the width of the recording paper to be the recording medium 41, it does not need to be reciprocated in the perpendicular direction to the secondary scanning direction Y.

Since the reciprocation cannot be carried out, moreover, the liquid ejecting portion 52 is not provided differently from the recording apparatus A including the recording head 1 of the serial head type in FIG. 1. Since the other structures are the same as those of the case shown in FIG. 1, description thereof will be omitted.

In the following, although the recording head 1 of the serial head type (see FIG. 1) and the recording head 60 of the line head type (see FIG. 5) are varied as to whether the recording head is moved in the image formation or not, they have the same basic structure. For this reason, description will be given to the case of the recording apparatus A having the recording head 1 of the serial head type in FIG. 1, and a peculiar structure to the recording apparatus A having the recording head 60 of the line head type will be described at each time.

In FIGS. 2 to 4, 2 denotes a recording head body, 3 denotes a concave portion, 3a denotes a liquid supplying port, 3b denotes a liquid ejecting port, 4 denotes a pressure chamber, 6 denotes a pressure chamber component, 7 denotes a liquid passage component, 7a to 7f denote a stainless steel plate, 8 denotes an orifice, 9 denotes a nozzle plate, 9a denotes a water repellent film, 11 denotes a feeding liquid passage, 12 denotes an ejecting liquid passage, 14 denotes a nozzle, 21 denotes a piezoelectric actuator, 22 denotes a diaphragm, 23 denotes a piezoelectric element, 24 denotes an individual electrode, and 25 denotes an intermediate layer.

As shown in FIGS. 2 to 4, the recording head 1 includes the recording head body 2 provided with a plurality of concave portions 3 for a pressure chamber which includes a supplying port 3a for supplying a liquid and an ejecting port 3b for ejecting the liquid. The respective concave portions 3 of the recording head body 2 are opened on an upper surface of the recording head body 2 so as to be extended in a primary scanning direction X, and are arranged at an almost regular interval from each other in a secondary scanning direction Y. An overall length of the opening of each concave portion 3 (a length in the primary scanning direction X) is set to be approximately 1250 μm, for example, and a width (a length in the secondary scanning direction Y) is set to be approximately 130 μm, for example. In the example, a sectional shape in a direction of a horizontal plane at both ends of the opening of the concave portion 3 is almost semicircular.

A sidewall portion of the concave portion 3 of the recording head body 2 is constituted by the pressure chamber component 6 formed of a photosensitive glass having a thickness of approximately 200 μm, and a bottom wall portion of the concave portion 3 is constituted by the liquid passage component 7 bonded and fixed to a lower surface of the pressure chamber component 6 and having six stainless steel sheets 7a to 7f laminated thereon. A plurality of orifices 8 connected to the supplying ports 3a of the concave portions 3 respectively, a supplying liquid passage 11 connected to each of the orifices 8 and extended in the secondary scanning direction Y, and a plurality of ejecting liquid passages 12 connected to the ejecting ports 3b respectively are formed in the liquid passage component 7.

Each orifice 8 is formed on the stainless steel sheet 7b which is thinner than any other sheet in the liquid passage component 7 and is provided in a second position from a top, and has a diameter set to be approximately 38 μm. Moreover, the supplying liquid passage 11 is connected to the liquid cartridge 35, and the liquid is supplied from the liquid cartridge 35 into the supplying liquid passage 11.

The nozzle plate 9 formed of stainless steel is bonded and fixed to a lower surface of the liquid passage component 7 (the stainless steel sheet 7f), and a lower surface of the nozzle plate 9 is covered with the water repellent film 9a. A plurality of nozzles 14 for ejecting a liquid droplet 15 toward the recording medium 41 is formed to be arranged in a line in the secondary scanning direction Y over a lower surface of the recording head 1 in the nozzle plate 9 (see FIGS. 2 and 3). The respective nozzles 14 are connected to the ejecting liquid passages 12 respectively, and communicate with the ejecting ports 3b of the concave portions 3 through the ejecting liquid passages 12. Each of the nozzles 14 is constituted by a taper portion having a nozzle diameter reduced toward a nozzle tip side in the nozzle plate 9 and a straight portion linked to the nozzle tip side of the taper portion and having an almost equal diameter, and the nozzle diameter of the straight portion is set to be approximately 20 μm.

The piezoelectric actuators 21 are provided on an upper side of the concave portions 3 of the recording head body 2, respectively. Each of the piezoelectric actuators 21 is bonded and fixed to an upper surface of the recording head body 2 and closes the concave portion 3 of the recording head body 2 in this state, and thus constitutes the pressure chamber 4 together with the concave portion 3. A lower portion thereof is provided with the diaphragm 22 formed of Cr, for example. The diaphragm 22 is formed to be common to all of the piezoelectric actuators 21 provided on the recording head body 2 and also serves as a common electrode which is common to all of the piezoelectric elements 23 which will be described below.

Moreover, each of the piezoelectric actuators 21 is provided through the intermediate layer 25 formed of Cu in a portion corresponding to the pressure chamber 4 on a surface (an upper surface) of the diaphragm 22 at an opposite side of the pressure chamber 4 (a portion opposed to the opening of the concave portion 3), and has the piezoelectric element 23 formed of lead zirconate titanate (PZT) and the individual electrode 24 formed of Pt which is bonded to a surface (an upper surface) of the piezoelectric element 23 on an opposite side of the diaphragm 22 and serves to apply a voltage (a driving voltage) to the piezoelectric element 23.

All of the diaphragm 22, the piezoelectric element 23, the individual electrode 24 and the intermediate layer 25 which constitute the piezoelectric actuator 21 are formed by thin films. In the first embodiment, for example, a thickness of the diaphragm 22 is set to be approximately 6 μm, a thickness of the piezoelectric element 23 is set to be equal to or smaller than 8 μm (for example, approximately 3 μm), a thickness of the individual electrode 24 is set to be approximately 0.2 μm, and a thickness of the intermediate layer 25 is set to be approximately 3 μm.

The recording apparatus A comprises a flushing ejection control portion for carrying out flushing ejection for flushing in the liquid passage and the nozzle opening portion in the recording head 1. The flushing ejection control portion starts the flushing ejection every time of 100 sec or less. Consequently, it is possible to further enhance the effect of preventing a liquid solvent component from being dried over a liquid meniscus surface of the nozzle opening portion. Since the flushing ejection control portion carries out excessive flushing and an amount of consumption of the liquid is unnecessarily increased when the flushing ejection exceeds continuous 1,000 times, it is not proper. For this reason, the flushing ejection control portion is set to carry out continuous ejection of one to 1,000 shots. The flushing ejection is carried out at an equal ejection driving frequency to that in a recording operation so that an ejection control can be simplified.

In case of the recording apparatus A having the recording head 1 of the serial head type shown in FIG. 1, the flushing ejection control portion carries out the flushing ejection when the recording head 1 is positioned on the liquid ejecting portion 52. In case of the recording apparatus A having the recording head 60 of the line head type shown in FIG. 5, the flushing ejection to the recording medium 41 is carried out with the recording operation maintained. In case of the recording apparatus A having the recording head 60 of the line head type, it is possible to carry out high speed recording without interrupting the recording operation.

The flushing ejection control portion is constituted in a control board 80 to be mounted on the recording apparatus A, for example. The control board 80 is usually provided with a microprocessor (which will be hereinafter referred to as a CPU 90), and furthermore, an ROM, an RAM, an analog/digital converter, other well-known electronic components and circuits which are not shown, and the CPU 90 controls the whole operation of the recording apparatus A based on a program stored in a nonvolatile memory such as an ROM, and furthermore, executes the flushing ejection in the timing.

Next, the structure of the ink jet recording apparatus according to the first embodiment will be mainly described with reference to FIG. 1.

In the first embodiment, the recording apparatus A further comprises the humidifier 51 provided on an upstream side (a B side shown in FIGS. 1 and 5) in a feeding direction of the recording medium 41 in non-contact with the recording surface side of the recording medium 41 by setting, as a base point, a position in which the nozzle 14 is provided, a humidity detecting portion 81 for detecting a humidity of air in the vicinity of the nozzle, a nozzle surface temperature detecting portion 82 for detecting a temperature of the nozzle surface, a nozzle vicinity air temperature detecting portion 83 for detecting a temperature of air in the vicinity of the nozzle, and a humidifying portion driving control portion for controlling a driving operation of the humidifier 51 (which will be described below) corresponding to an absolute humidity and a relative humidity of the air in the vicinity of the nozzle which are detected by using the humidity detecting portion 81, the nozzle surface temperature detecting portion 82 and the nozzle vicinity air temperature detecting portion 83.

In the first embodiment, a humidity sensor of an electrostatic capacity type for measuring a relative humidity is used as the humidity detecting portion 81. The humidity sensor of the electrostatic capacity type utilizes such a property that an electrostatic capacity is changed corresponding to an amount of moisture adsorbed by a wet and dry material such as a cellulose based hydrophilic polymer and can carry out a high speed response, and has a wide measuring range (0 to 100% RH) and can obtain a straight output for the relative humidity so that a matching property with a subsequent treatment can easily be taken. For the measurement of the relative humidity, it is also possible to use a so-called ceramic sensor.

In the first embodiment, moreover, a so-called pyroelectric sensor is used for the nozzle surface temperature detecting portion 82. The pyroelectric sensor serves to detect infrared rays, thereby detecting a temperature of an object, and can detect a temperature in non-contact. When the recording head 1 provided on the carriage shaft 32 passes through an upper part of the nozzle surface temperature detecting portion 82 constituted by the pyroelectric sensor, a temperature of the nozzle surface is measured.

In the first embodiment, furthermore, a comparatively inexpensive available thermistor is used as the nozzle vicinity air temperature detecting portion 83 for detecting a temperature of air in the vicinity of the nozzle.

The temperature of the nozzle surface which is measured by the nozzle surface temperature detecting portion 82 and the air temperature in the vicinity of the nozzle which is detected by the nozzle vicinity air temperature detecting portion 83 are converted into a digital signal through an analog/digital converter (not shown) loaded onto the control board 80, and the digital signal is processed by the CPU 90 and is output as an ambient temperature value. Various equations in this case can be proposed. For example, both outputs may be averaged. In the case in which a printing ratio is high and a rise in the nozzle temperature is remarkable, moreover, the equation may be dynamically changed to mainly use an output value of the nozzle vicinity air temperature detecting portion 83 and to supplementally the temperature of the nozzle surface.

By using a result of the calculation of the relative humidity and the ambient temperature value, it is possible to obtain an absolute humidity in the vicinity of the nozzle surface by a calculation. More specifically, the CPU 90 previously refers to a look-up table (LUT) stored in the ROM provided on the control board 80 to obtain an amount of saturated vapor at the temperature and calculates the absolute humidity from the value and the relative humidity based on a result of the measurement of the ambient temperature value. In other words, the humidity detecting portion according to the first embodiment substantially includes the humidity detecting portion 81 and a processing portion, for example, the CPU 90 for processing an output of the humidity detecting portion 81 to obtain an absolute humidity.

While the absolute humidity is obtained by the calculation as described above in the first embodiment, thus, the relative humidity and the absolute humidity may be detected by special humid detecting portions, respectively.

In the description, the humidity detecting portion 81 and the nozzle vicinity air temperature detecting portion 83 are provided in the moving space of the carriage 31. In the ink jet recording apparatus having the recording head 1 of the serial head type shown in FIG. 1, however, they may be provided as a humidity detecting portion 85 and a nozzle vicinity air temperature detecting portion 86 in the carriage 31.

By employing the structure, the humidity detecting portion 85 and the nozzle vicinity air temperature detecting portion 86 are moved with the movement (scan operation) of the carriage 31. By setting a detection timing at plural times in a process of one scan operation, therefore, it is possible to detect a temperature and humidity atmosphere of a whole carriage moving space which does not depend on the position of the carriage 31. Consequently, precision in the control can be enhanced.

Next, the structure of the ink jet recording apparatus having the recording head 60 of the line head type will be described with reference to FIG. 5.

As shown in FIG. 5, the humidity detecting portion 81 and the nozzle vicinity air temperature detecting portion 83 are disposed on the side of the recording head 60. On the other hand, the nozzle surface temperature detecting portion 82 is disposed on an outside of a delivery region in an orthogonal direction to the delivery direction Y of the recording medium 41 opposite to a lower surface of the recording head 60 (a portion hidden by the recording head 60 in FIG. 5). A so-called dummy nozzle is provided on a nozzle surface corresponding to a position in which the nozzle surface temperature detecting portion 82 is disposed, and has such a structure as to carry out idle hitting in a predetermined amount (for example, the average number of ejecting times which is determined corresponding to a use ratio of the whole nozzle), thereby artificially detecting the temperature of the nozzle surface in a state in which the supply of a liquefied ejected substance such as an ink is blocked.

Returning to FIG. 1, description will be continuously given.

The humidifier 51 is disposed in such a manner that humidified air (vapor) generated by the humidifier 51 flows in the feeding direction of the recording medium 41. Consequently, the humidified air (vapor) is efficiently supplied to a surface of the nozzle plate 9 of the recording head body 2. Although the humidifier 51 is suitably provided as shown in FIGS. 1 and 5, it is possible to produce the same advantages by providing the humidifier 51 on an outside of the recording apparatus A to supply the sufficient humidified air (vapor) to the nozzle surface of the recording head body 2.

A type of a humidifying method which can be utilized in the humidifier 51 is roughly divided into three types including a water spraying method, a vapor spraying method and a vaporizing method. The water spraying method is classified more finely into a fluid nozzle method, an ultrasonic method and a centrifugal method. Moreover, the vapor spraying method is classified further finely into a vapor boiler method, a vapor dish method, an electrode method and an electric heating method. Furthermore, the vaporizing method is classified more finely into a rotating method, a stationary method and a moisture permeating film method.

The humidifier 51 is driven by the humidifying portion driving control portion.

The humidifying portion driving control portion is constituted on the control board 80 and includes a control circuit (not shown) constituted by an analog/digital converting portion for converting, into digital signals, output signals (analog level signals) of the humidity detecting portion 81, the nozzle surface temperature detecting portion 82 and the nozzle vicinity air temperature detecting portion 83 which are disposed in the vicinity of a space in which at least the recording head 1 is reciprocated, the CPU 90 for calculating the digitized signal, and a switching transistor for controlling a driving state of the humidifier 51 based on a result of the calculation obtained by the CPU 90.

The humidifying portion driving control portion carries out a so-called feedback control based on the outputs (multioutputs) of the humidity detecting portion 81, the nozzle surface temperature detecting portion 82 and the nozzle vicinity air temperature detecting portion 83. Since one output corresponds to the humidifier 51, however, it is preferable to use a fuzzy inference in order to determine a control target value thereof, for example.

Moreover, the amount of humidification through the humidifier 51 is obtained more effectively by the execution of minute steps. In the first embodiment, therefore, an inverter circuit is used as the control circuit and the amount of humidification is regulated minutely. Even if a conducting time for the humidifier 51 is controlled by a PWM control in addition to the inverter circuit, for example, the same advantages can be obtained.

The humidifying portion driving control portion suitably controls the humidifying portion 51 to drive the humidifier 51 when the absolute humidity of air in the vicinity of the nozzle is lower than 5 g/m³ and to stop the driving operation of the humidifier 51 with a relative humidity of 100% RH. Consequently, it is possible to prevent vapor from being supplied unnecessarily. Moreover, the humidifying portion driving control portion controls the humidifier 51 in such a manner that the temperature of the nozzle vicinity air is equal to or lower than a nozzle surface temperature. By setting the nozzle vicinity air temperature to be equal to or lower than the nozzle surface temperature, thus, it is possible to prevent a condensation on the nozzle surface, and flight bending and non-ejection of liquid droplets.

The operation of the recording apparatus A having the structure will be described with reference to FIG. 1.

First of all, when the recording medium 41 is set into a predetermined position for carrying out a print processing by a portion for supplying the recording medium 41 which is not shown and the delivery roller 42, a relative humidity, a nozzle surface temperature and a nozzle vicinity air temperature are detected by the humidity detecting portion 81, the nozzle surface temperature detecting portion 82 and the nozzle vicinity air temperature detecting portion 83, respectively. By the structure, the absolute humidity of the nozzle surface is calculated by the nozzle surface temperature and the relative humidity. Then, the humidifying portion driving control portion controls to drive the humidified air from the humidifier 51 in such a manner that the detected relative humidity is lower than 100% RH and the calculated absolute humidity is equal to or higher than 5 g/m³. In this case, when the humidifier 51 is controlled in such a manner that the temperature of the air in the vicinity of the nozzle is equal to or lower than the temperature of the nozzle surface, the condensation is effectively suppressed.

When the condition of the humidity of the air in the vicinity of the nozzle is well regulated, the recording head 1 and the carriage 31 are guided by the carriage shaft 32 through the carriage motor and are thus delivered at a predetermined speed in the primary scanning direction. In the delivery, a processing of ejecting the liquid in the recording head 1 is carried out.

An operation for the processing of ejecting the liquid in the recording head 1 of the recording apparatus A will be mainly described below with reference to FIGS. 3 and 4. The piezoelectric actuator 21 applies a driving voltage to the piezoelectric element 23 through the diaphragm 22 and the individual electrode 24 to deform a portion of the diaphragm 22 which corresponds to the pressure chamber 4 (an opening part of the concave portion 3), thereby ejecting the liquid in the pressure chamber 4 from the ejecting port 3b or the nozzle 14.

More specifically, a pulse-shaped voltage is applied between the diaphragm 22 and the individual electrode 24, the piezoelectric element 23 is contracted in a transverse direction which is perpendicular to a direction of a thickness by a piezoelectric effect with a rise of the pulse voltage. On the other hand, the diaphragm 22, the individual electrode 24 and the intermediate layer 25 are not contracted. Therefore, the portion of the diaphragm 22 which corresponds to the pressure chamber 4 is flexed and deformed to be convex toward the pressure chamber 4 side by a so-called bimetal effect. By the flexing deformation, a pressure in the pressure chamber 4 is raised and the liquid in the pressure chamber 4 is pushed out of the nozzle 14 via the ejecting port 3b and the ejecting liquid passage 12 through the pressure. Then, the piezoelectric element 23 is extended with a fall of the pulse voltage so that the portion of the diaphragm 22 which is opposed to the pressure chamber 4 is recovered into the original state. At this time, the liquid pushed out of the nozzle 14 is broken from the liquid in the ejecting liquid passage 12 and is ejected as a liquid droplet 15 (for example, 3 pl) to the recording medium 41, and is stuck to the surface of the recording medium 41 like a dot. When the diaphragm 22 is recovered into the original state from the convex flexing and deforming state, moreover, the liquid is filled from the liquid cartridge 35 into the pressure chamber 4 through the supplying liquid passage 11 and the supplying port 3a. The pulse voltage to be applied to the piezoelectric element 23 may be of a pull-push type for carrying out a rise to a first voltage after a fall from the first voltage to a second voltage which is lower than the first voltage in place of a push-pull type for deforming the diaphragm 22 to be convex and recovering the diaphragm 22 into the original state as described above.

The application of the driving voltage to the piezoelectric element 23 is carried out every predetermined time (for example, approximately 50 μs: an ejection driving frequency of 20 kHz) when the recording head 1 and the carriage 31 are moved from one of ends of the recording medium 41 to the other end in the primary scanning direction at an almost constant speed in the recording apparatus A shown in FIG. 1 (it is assumed that the voltage is not applied when the recording head 1 reaches a place in the recording medium 41 in which the liquid droplet 15 is not caused to get down. Consequently, the liquid droplet 15 is caused to get down into a predetermined position of the recording medium 41. When a recording operation corresponding to one scan is ended, the delivery motor controls the delivery roller 42 in such a manner that the recording medium 41 is delivered in a predetermined amount in the secondary scanning direction and then ejects the liquid droplet 15 while moving the recording head 1 and the carriage 31 in the primary scanning direction again, and thus carries out a new recording operation corresponding to one scan. By repeating the operation, a desirable image is formed on the whole recording medium 41.

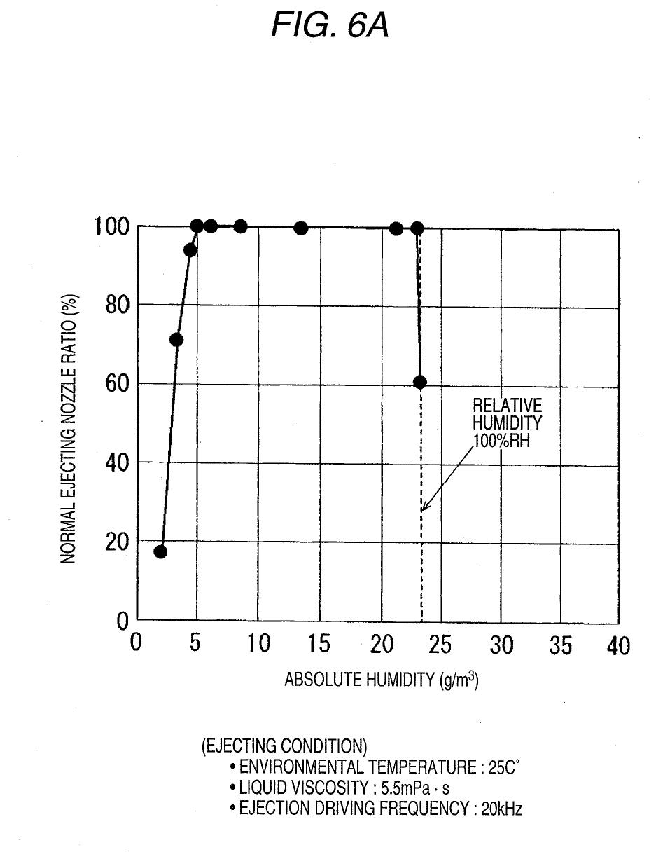

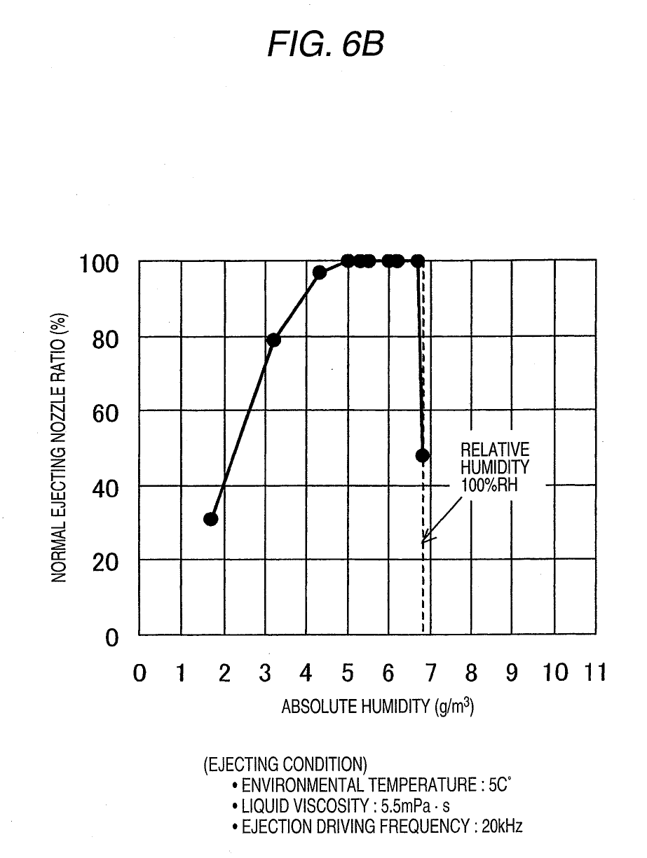

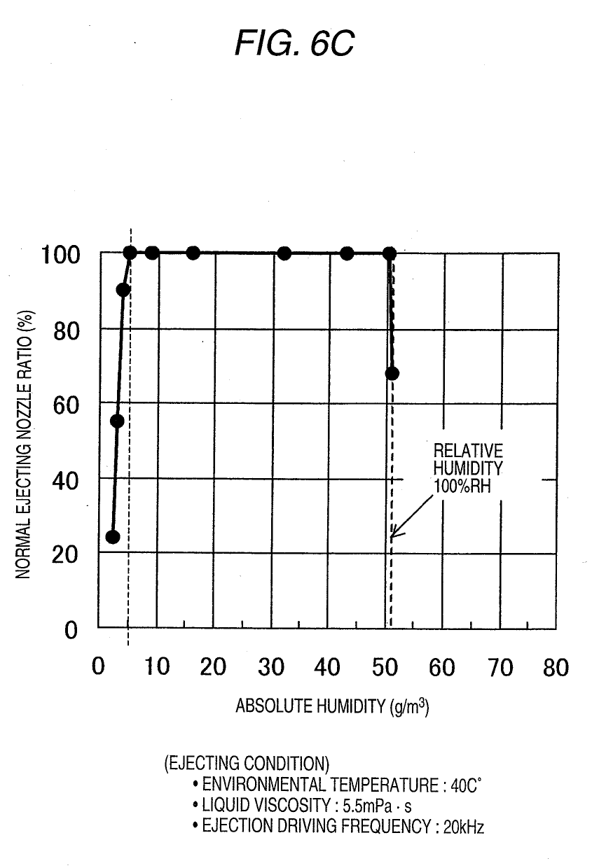

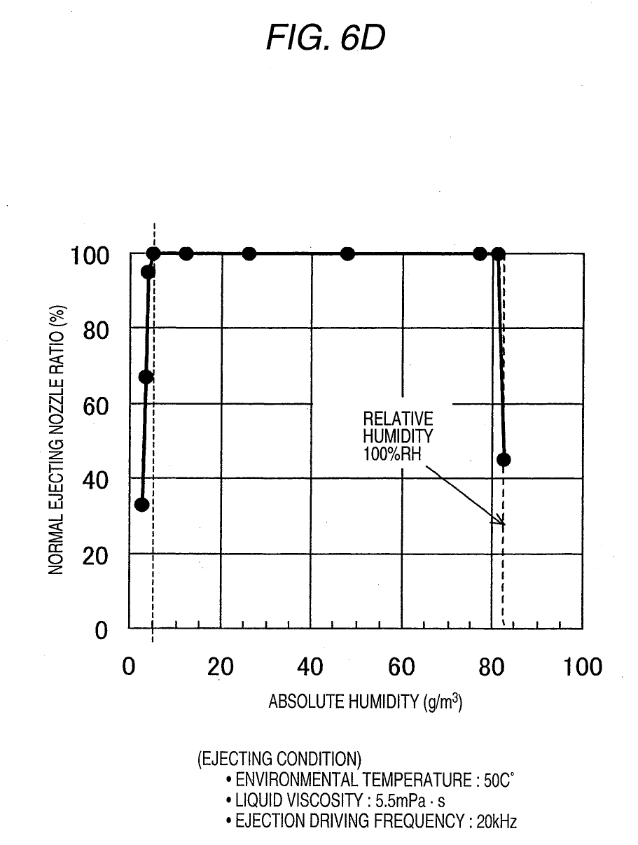

FIGS. 6A, 6B, 6C and 6D are graphs showing a result obtained by measuring an air humidity dependency in the vicinity of the nozzle for ejecting the liquid droplet according to the first embodiment of the invention.

FIGS. 6A, 6B, 6C and 6D show a result obtained by measuring the air humidity dependency in the vicinity of the nozzle for filling the aqueous liquid (for example, an ink for ink jet recording) in the recording head 1 of a serial head type in which 400 nozzles are disposed and ejecting the liquid droplet in the driving operation of the recording head 1.

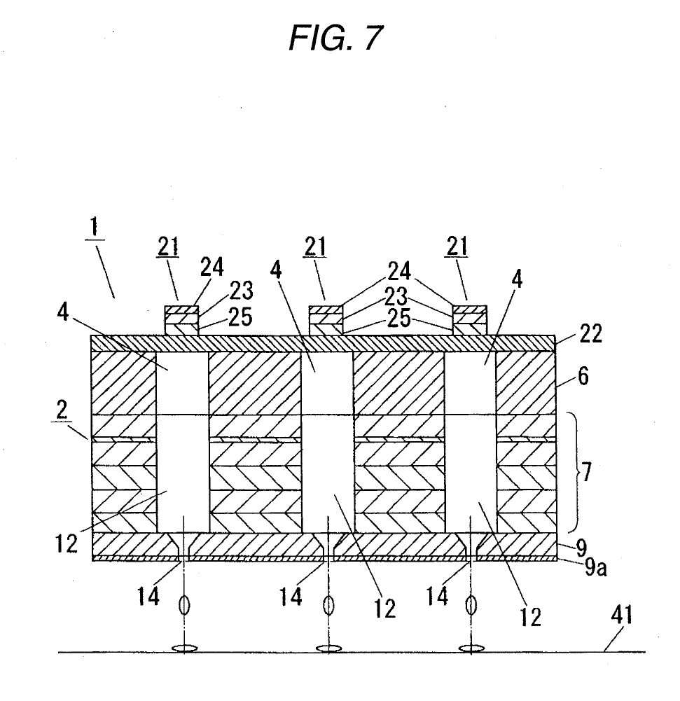

FIG. 7 is an explanatory view typically showing a state in which the amount of ejection of the liquid droplet is insufficient in the recording head according to the first embodiment of the invention.

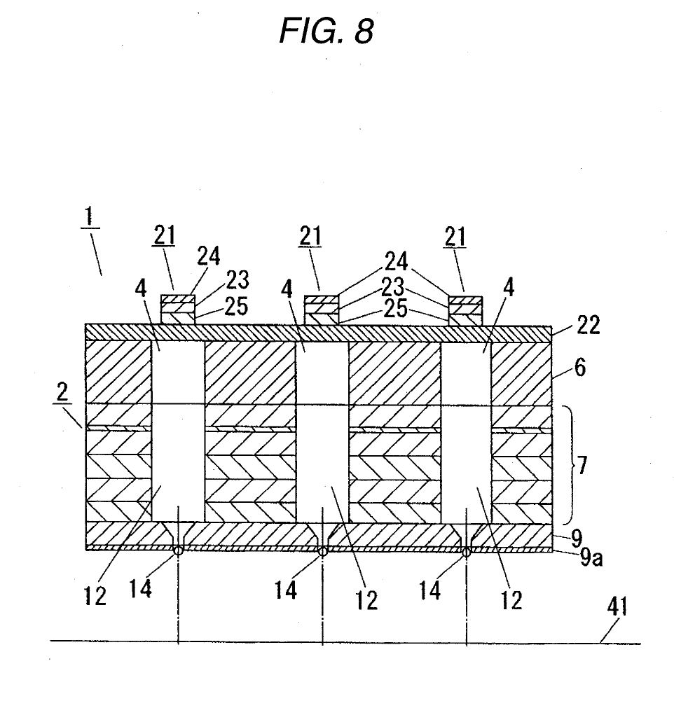

FIG. 8 is an explanatory view typically showing a state in which the nozzle is clogged with the liquid droplet in the recording head according to the first embodiment of the invention.

Both of FIGS. 7 and 8 correspond to FIG. 3, in which the liquid droplet ejected from the nozzle in FIG. 3 is shown to be standard.

As a condition for obtaining FIG. 6A, an ejecting environmental temperature=25° C., a viscosity of a liquid to be used=5.5 mPa·s, and an ejection driving frequency=20 kHz are set.

As a condition for obtaining FIG. 6B, an ejecting environmental temperature=5° C., a viscosity of a liquid to be used=5.5 mPa·s, and an ejection driving frequency=20 kHz are set.

As a condition for obtaining FIG. 6C, an ejecting environmental temperature=40° C., a viscosity of a liquid to be used=5.5 mPa·s, and an ejection driving frequency=20 kHz are set.

As a condition for obtaining FIG. 6D, an ejecting environmental temperature=50° C., a viscosity of a liquid to be used=5.5 mPa·s, and an ejection driving frequency=20 kHz are set.

In FIGS. 6A, 6B, 6C and 6D, moreover, an axis of abscissas indicates an absolute humidity (g/m³) of air in the vicinity of the nozzle and an axis of ordinates indicates a normal ejecting nozzle ratio (%). In these drawings, a scale of the axis of abscissas is regulated individually.

From the drawings, it is apparent that the normal ejecting nozzle ratio is rapidly reduced when the absolute humidity of the air in the vicinity of the nozzle is lower than 5 g/m³ at any environmental temperature.

The reason is as follows. When the absolute humidity is lower than 5 g/m³, a vapor covering rate of the liquid meniscus surface of the nozzle opening portion is reduced and an amount of water dissolution from vapor into a liquid (that is, an amount of moisture to be supplied to the liquid) becomes insufficient so that an amount of moisture drying is larger than an amount of supply of water to thicken the liquid. As a result, the amount of the liquid droplet which is ejected is insufficient as shown in FIG. 7 and the nozzle is easily clogged with the liquid droplet as shown in FIG. 8.

On the other hand, also on any environmental condition, the nozzle surface is condensed with a relative humidity of 100% RH, thereby causing the flight bending or non-ejection of the liquid droplet, which is not preferable.

For example, neither the flight bending nor the non-ejection of the liquid droplet is caused in an ejecting environment of 25° C. and 99% RH (an absolute humidity of 22.7 g/m³) shown in FIG. 6A, and the ejection is normally carried out and a condensation is generated on the nozzle surface to cause the flight bending of the liquid droplet at 25° C. and 100% RH (an absolute humidity of 23.0 g/m³) as shown in FIG. 3. At an environmental temperature of 5° C., 40° C. and 50° C., the same tendency is exhibited.

It has been confirmed that the air in the vicinity of the nozzle for normally ejecting the liquid has an absolute humidity of 5 g/m³ or more and a relative humidity of less than 100% RH also at an ejecting environmental temperature other than that shown in each of FIGS. 6A, 6B, 6C and 6D as long as at least an environmental temperature meets a condition of 5° C. to 50° C.

In general, an operating environmental temperature (an operating guaranteed temperature) of an ink jet recording apparatus is set to be 5 to 35° C. However, it is apparent that a performance which greatly exceeds the range can be maintained in the ink jet recording apparatus according to the first embodiment.

However, when the environmental temperature is reduced to 0° C., for example, an ink viscosity is extremely increased or freezing is started so that the ejection of the ink becomes unstable. To the contrary, an ink coloring material constituted by a dye or a pigment causes aggregation, sedimentation, fixing or a change of color in an ink passage tube, an inside of a head actuator or an ink passage system such as a head nozzle hole in a high temperature region or a head material, an ink passage based material and an adhesive material are damaged in some cases. For this reason, it is desirable that an ambient temperature in the vicinity of the nozzle should be actually equal to or lower than 40° C. Also in this respect, there is a significance for humidifying a surrounding portion of the recording head in the ink jet recording apparatus. The reason is that a vaporization heat is taken away from the surrounding portion of the recording head and the ambient temperature can be effectively reduced when the humidified vapor is to be vaporized.

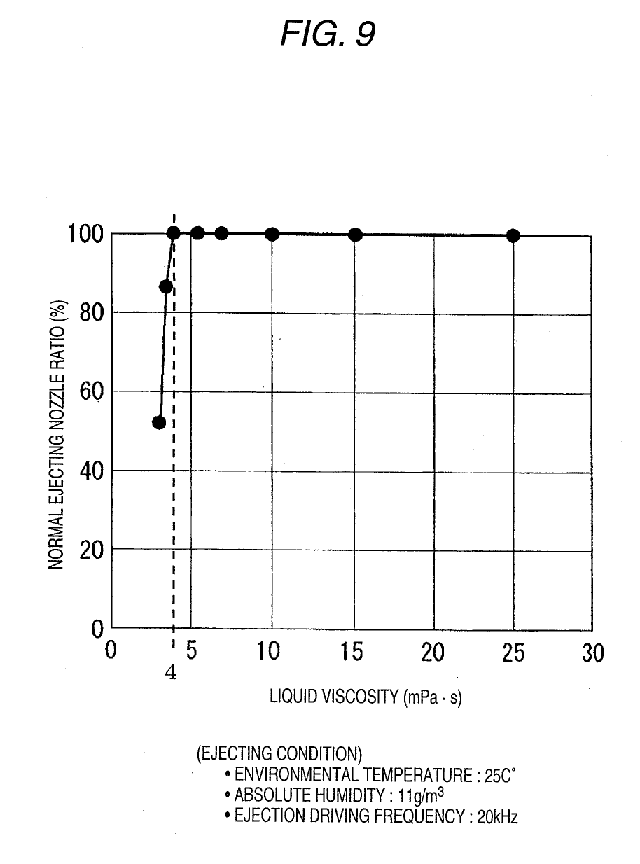

FIG. 9 is a graph showing a result obtained by measuring a viscosity dependency of an aqueous liquid in the first embodiment of the invention.

FIG. 9 shows a result obtained by measuring a viscosity dependency of an aqueous liquid when the aqueous liquid is filled in the recording head 1 of a serial head type provided with 400 nozzles and the recording head 1 is driven to eject liquid droplets.

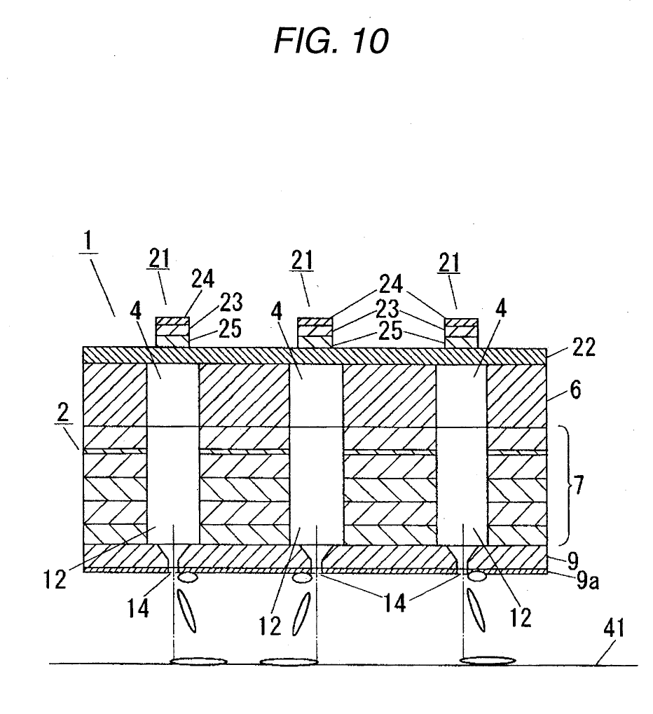

FIG. 10 is an explanatory view typically showing a state in which the liquid droplets ejected from the recording head cause flight bending in the first embodiment of the invention.

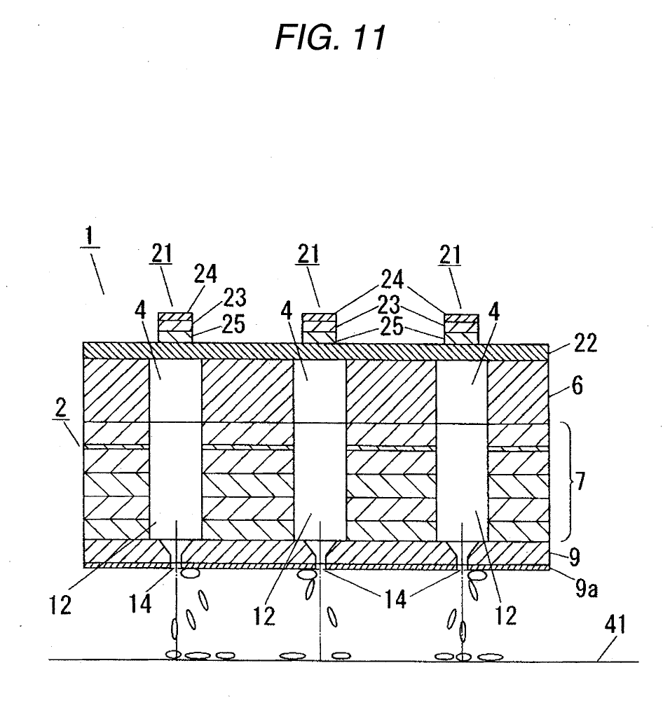

FIG. 11 is an explanatory view typically showing a state in which the liquid droplets ejected from the recording head cause scattering in the first embodiment of the invention.

Both of FIGS. 10 and 11 correspond to FIG. 3, in which the liquid droplet ejected from the nozzle in FIG. 3 is shown to be standard.

As a condition for obtaining FIG. 9, in case of an ejecting environmental temperature=25° C., an absolute humidity of an ejecting environment=11 g/m³ and an ejection driving frequency of 20 kHz are set.

In the drawing, an axis of abscissas indicates a viscosity (mPa·s) of an aqueous liquid and an axis of ordinates indicates a normal ejecting nozzle ratio (%). A test was carried out by varying a composition of the aqueous liquid in such a manner that the viscosity of the aqueous liquid ranges from 3 mPa·s to 25 mPa·s.

From FIG. 9, when the viscosity of the liquid is lower than 4 mPa·s, a liquid meniscus is formed unstably in the opening portion of the nozzle as shown in FIGS. 10 and 11. Even if the drying of the solvent of the liquid droplet can be prevented by the humidification carried out by the humidifier 51, it is impossible to suppress the flight bending of the liquid droplet shown in FIG. 10 and scattering of the liquid droplet shown in FIG. 11. Consequently, it is hard to perform a recording operation of high picture quality. For this reason, it is desirable that the viscosity of the liquid which indicates the normal liquid ejection should be equal to or higher than 4 mPa·s. In particular, the viscosity range is effective for high speed recording at an ejection driving frequency of 10 kHz or more.

There will be described an example of a composition of the aqueous liquid which can be used in the first embodiment.

| | |
|---|---|
| Acid yellow 23: | 5 wt % |
| Glycerin: | 20 wt % |
| Pure water: | 75 wt % |

By using the aqueous liquid having the composition, it is possible to obtain a viscosity of 4 mPa·s or more.

There will be described another example of the composition of the aqueous liquid which can be used in the first embodiment.

| | |
|---|---|
| Acid yellow 23: | 5 w % |
| Glycerin: | 20 w % |
| DEGMBE: | 5 w % |
| Pure water: | 70 w % |

By using the aqueous liquid having the composition, it is possible to obtain a viscosity of 4 mPa·s or more.

In the case in which the aqueous liquids having the compositions are used, it is possible to regulate the vicinity by varying a concentration of the glycerin.

As described above in detail, the first embodiment includes the following invention.

(1) An ink jet recording apparatus according to the first embodiment comprises a recording head for ejecting a liquid droplet from a nozzle based on an ejecting signal to form a pattern on a recording medium, a humidity detecting portion for detecting an absolute humidity in the vicinity of the nozzle, a humidifying portion for humidifying the vicinity of the nozzle, and a humidifying portion driving control portion for controlling the humidifying portion based on the absolute humidity detected by the humidity detecting portion.

Consequently, it is possible to define, as the absolute humidity, a humidity for preventing the liquid from being thickened by the drying of a liquid solvent component over a liquid meniscus surface of an opening portion of the nozzle and effectively preventing an insufficient amount of the liquid droplets which are ejected, nozzle clogging, flight bending and non-ejection. In a high speed recording operation at an ejection driving frequency of 10 kHz or more in the ink jet recording apparatus, moreover, a liquid meniscus of the opening portion of the nozzle can be formed stably and the liquid droplets which are ejected can be prevented from causing flight bending and scattering. Also in the high speed recording, thus, it is possible to achieve a recording operation of high picture quality.

(2) In the embodiment, moreover, an ink jet recording apparatus comprises a recording head for ejecting a liquid droplet from a nozzle based on an ejecting signal to form a pattern on a recording medium, a humidity detecting portion for detecting an absolute humidity and a relative humidity of air in the vicinity of the nozzle, a humidifying portion for supplying humidified air to the vicinity of the nozzle, and a humidifying portion driving control portion for controlling a driving operation of the humidifying portion in such a manner that the absolute humidity of the air in the vicinity of the nozzle which is obtained by the humidity detecting portion is equal to or higher than 5 g/m³ and the relative humidity is lower than 100% RH.

Consequently, it is possible to define, as the absolute humidity, a humidity for preventing the liquid from being thickened by the drying of a liquid solvent component over a liquid meniscus surface of an opening portion of the nozzle and effectively preventing an insufficient amount of the liquid droplets which are ejected, nozzle clogging, flight bending and non-ejection, and furthermore, to prevent unnecessary humidification. In a high speed recording operation at an ejection driving frequency of 10 kHz or more in the ink jet recording apparatus, moreover, a liquid meniscus of the opening portion of the nozzle can be formed stably and the liquid droplets which are ejected can be prevented from causing flight bending and scattering. Also in the high speed recording, thus, it is possible to achieve a recording operation of high picture quality.

(3) In the embodiment, furthermore, the humidifying portion is provided on a recording surface side of the recording medium so as not to come in contact with the recording medium. Consequently, the humidified air (vapor) generated in the humidifying portion can be efficiently supplied to the nozzle surface.

(4) In the embodiment, moreover, the humidifying portion is provided on an upstream side in a feeding direction of the recording medium by setting, as a base point, a position in which the nozzle is to be provided. Consequently, the humidified air (vapor) generated in the humidifying portion flows in a feeding direction of the recording medium and can be efficiently supplied to the nozzle surface.

(5) In the embodiment, furthermore, there are further provided a nozzle vicinity air temperature detecting portion for detecting a temperature of air in the vicinity of the nozzle; and a nozzle surface temperature detecting portion for detecting a temperature of a nozzle surface, and the humidifying portion driving control portion controls the humidifying portion in such a manner that the temperature of the air in the vicinity of the nozzle is equal to or lower than the temperature of the nozzle surface. Consequently, it is possible to prevent a condensation of the nozzle surface and to suppress the flight bending and non-ejection of the liquid droplet.

(6) In the embodiment, moreover, there is further provided a flushing ejection control portion for carrying out flushing ejection for a liquid passage and a nozzle opening portion in the recording head. Consequently, the liquid having a high viscosity in the liquid passage and the opening portion of the nozzle in the recording head is ejected.

(7) In the embodiment, furthermore, the flushing ejection control portion executes the flushing ejection at a time of 100 sec or less. Consequently, it is possible to prevent a liquid solvent component from being dried over the liquid meniscus surface of the opening portion of the nozzle.

(8) In the embodiment, moreover, the flushing ejection control portion carries out the flushing ejection in a continuous ejection of 1 to 1000 shots. Consequently, it is possible to suppress excessive flushing, thereby preventing an unnecessary increase in an amount of consumption of the liquid.

(9) In the embodiment, furthermore, the flushing ejection control portion carries out the flushing ejection at an equal ejection driving frequency to that in a recording operation. Consequently, an ejection control in the ink jet recording apparatus can be simplified.

(10) In the embodiment, moreover, the flushing ejection control portion carries out the flushing ejection over the recording medium while maintaining a recording operation. In an ink jet recording apparatus constituted by a recording head of a line head type, consequently, it is possible to carry out high speed recording without interrupting the recording operation.

(11) In the embodiment, furthermore, there is further provided a liquid ejecting portion in a place other than a place in which the recording medium is disposed and serving to receive a droplet ejected through flushing of the liquid passage and the nozzle opening portion in the recording head, and the flushing ejection control portion carries out the flushing ejection when the recording head is positioned on the liquid ejecting portion. In an ink jet recording apparatus constituted by a recording head of a serial head type, consequently, it is possible to carry out the recording operation without contaminating the recording medium at all.

(12) In the embodiment, moreover, the liquid contains water and a humectant. Consequently, it is possible to increase a water content efficiency of the liquid using the humidifying portion and to suppress the drying of the liquid solvent component.

(13) In the embodiment, furthermore, a viscosity of the liquid is set to be equal to or higher than 4 mPa·s. Consequently, it is possible to prevent the solvent of the liquid droplets from being dried and to prevent the liquid droplets from causing flight bending and scattering.

### Second Embodiment

A liquid for recording, for example, an ink which is to be used in an ink jet recording apparatus includes various liquids such as a water based liquid using water as a solvent, an oil based liquid using, as a solvent, hydrocarbon of a low molecular weight type, a solvent based liquid using ethanol as a solvent and an UV curing type liquid using a photopolymerizing initiator as a solvent depending on a type of a dry solvent to be used. The humidifier 51 (see FIG. 1) described in detail in the first embodiment serves to supply the humidified air (that is, vapor) and a recording liquid which can be used is limited to a liquid containing a water solvent.

An ink jet recording apparatus according to a second embodiment has an object to obtain a recording apparatus capable of preventing a recording liquid from being thickened by the driving of a solvent component over a liquid meniscus surface of an opening portion of a nozzle, preventing an insufficient amount of droplets ejected from the nozzle and nozzle clogging, and carrying out a recording operation of high picture quality with a high versatility without being conscious of a driving timing of the ink jet recording apparatus irrespective of a type of a dry solvent of a recording liquid to be used.

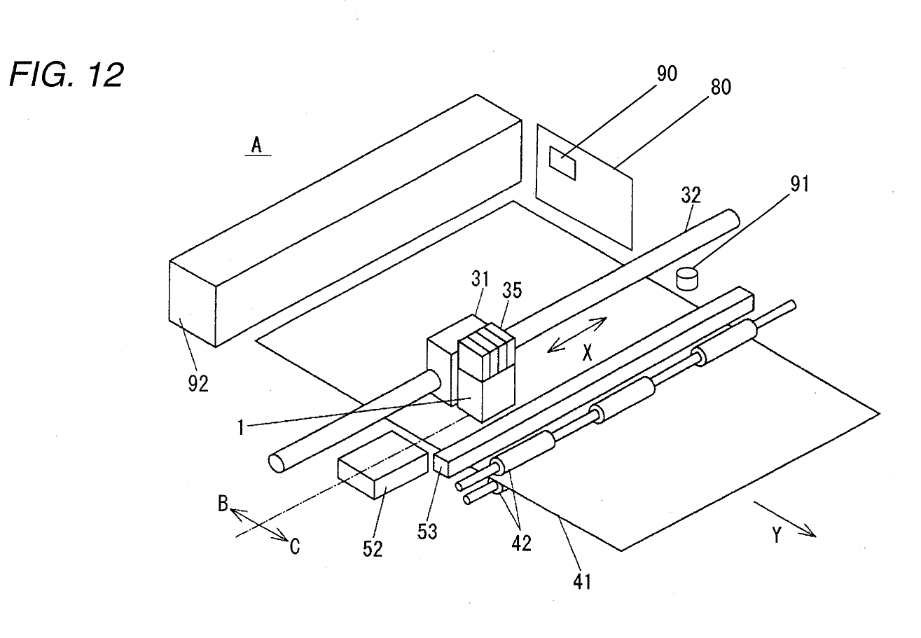

FIG. 12 is a view showing a schematic structure of an ink jet recording apparatus having a recording head of a serial head type according to the second embodiment of the invention.

Since the structure shown in FIG. 12 is basically equivalent to that of the ink jet recording apparatus having the recording head of the serial head type described in the first embodiment, description of common portions will be omitted.

A recording apparatus A shown in FIG. 12 is different from the structure according to the first embodiment in that a solvent vapor content detecting portion 91 is provided in place of the humidity detecting portion 81 (see FIG. 1) according to the first embodiment, a solvent vapor control portion 92 is provided in place of the humidifier 51 (see FIG. 1), and a solvent vapor collecting portion 53 which is not disposed in the first embodiment is provided.

The solvent vapor content detecting portion 91 detects a vapor content of a liquid solvent in the vicinity of a nozzle provided on a lower surface of a recording head 1. The solvent vapor control portion 92 is disposed across a recording medium 41 in a primary scanning direction X in non-contact with a recording surface of the recording medium 41 in a predetermined position on a supply side (a B side) of the recording medium 41 with respect to a position in which the recording head 1 is disposed over the recording medium 41, for example. The solvent vapor collecting portion 53 is disposed across the recording medium 41 in the primary scanning direction X in non-contact with the recording surface of the recording medium 41 in a predetermined position on an ejection side (a C side) of the recording medium 41 with respect to the position in which the recording head 1 is disposed over the recording medium 41. Moreover, a liquid ejecting portion 52 is disposed on one end side of a direction of movement of the recording head 1 (the primary scanning direction X) in a position placed out of a delivery path for the recording medium 41.

It is possible to propose various types of recording liquids to be used in the recording apparatus A according to the second embodiment depending on a solvent to be used:

(1) A water based liquid using water as a solvent;

(2) An oil based liquid using, as a solvent, hydrocarbon or silicone of a low molecular weight type;

(3) A solvent based liquid using, as a solvent, lower alcohol such as ethanol or isopropyl alcohol, cyclohexane, a diethylene glycol derivative, methyl ethyl ketone, ethylene glycol monobutyl ether acetate, N-methyl-2-pyrolidone or ethyl acetate; and

(4) AUV curing based liquid using a photopolymerizing initiator or acrylate as a solvent.

Moreover, the recording liquid considered in the second embodiment includes a liquid obtained by dissolving a so-called organic electroluminescence material or a material constituting an organic thin film transistor (for example, PPV (poly(p-phenylene vinylene))), polyfluorene and their derivatives) in toluene or xylene to be a solvent.

For the materials, a glass board or a ceramics board is used as the recording medium 41, for example.

All of the liquid solvents have a drying property and it is possible to indirectly weigh a vapor content by previously measuring a correlativeness of an amount of water contained in the vapor or a specific gas such as oxygen, carbon dioxide, carbon monoxide or hydrocarbon and a vapor content in the liquid solvent vapor to determine a calibration curve for an amount of one specific gas, and comparing the calibration curve with the amount of one specific gas which is actually measured.

As an apparatus for measuring the amount of water or a specific gas such as oxygen, carbon dioxide, carbon monoxide or hydrocarbon, moreover, it is possible to use a humidity indicator in case of vapor and a measuring apparatus having a detecting principle, for example, a gas thermally electrically-driven type, a diaphragm galvanic cell type, a zirconia limiting current method or an infrared ray absorbing method in case of oxygen, carbon dioxide, carbon monoxide and hydrocarbon.

In other words, the solvent vapor content detecting portion 91 detects the vapor content of the liquid solvent in the vicinity of the nozzle by the methods. The solvent vapor content detecting portion 91 serves to control the driving operation of the solvent vapor control portion 92 corresponding to the vapor content which is detected. The solvent vapor control portion 92 controls the generation of the solvent vapor upon receipt of a driving command. The solvent vapor generated by the solvent vapor control portion 92 flows from the supply side (the B side) toward the ejection side (the C side) over the recording medium 41. Therefore, the solvent vapor can be efficiently supplied to the nozzle surface of the nozzle plate 9 (see FIG. 3). Consequently, the solvent vapor control portion 92 is suitably provided in non-contact with the supply side (the B side) from a position on the recording medium 41 in which the recording head 1 is to be disposed. However, it is sufficient that the solvent vapor can be fully supplied to the nozzle surface. Therefore, it is also possible to dispose the solvent vapor control portion 92 on an outside of the supply side (the B side) which is not placed on the recording medium 41.

The type of a solvent vapor generating method which can be utilized in the solvent vapor control portion 92 is roughly divided into three types including a liquid spraying method, a vapor spraying method and a vaporizing method. The liquid spraying method includes a fluid nozzle method, an ultrasonic method and a centrifugal method. The vapor spraying method includes a vapor boiler method, a vapor dish method, an electrode method and an electric heating method. Furthermore, the vaporizing method includes a rotating method, a stationary method and a moisture permeating film method.

Various liquid solvents have been known as described above. Subsequently, description will be given to a relationship between the liquid solvent and “dry”. Consequently, the contents for controlling the driving operation of the solvent vapor control portion 92 corresponding to the vapor content which is detected will be made clear.

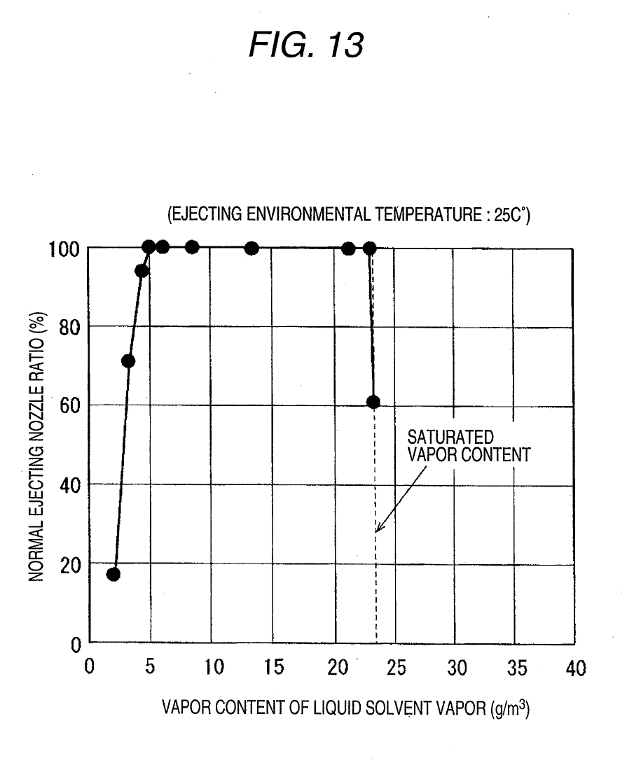

FIG. 13 is a characteristic chart showing a relationship between the liquid solvent vapor content in the vicinity of the nozzle and a normal ejecting nozzle ratio according to the second embodiment of the invention.

FIG. 13 shows a result obtained by filling a recording liquid using a water solvent having a specific gravity of ρ=1 in the liquid cartridge 35 of the recording head 1 provided with 400 nozzles and measuring a vapor content [g/m³] of the liquid solvent vapor in the vicinity of the nozzle with respect to the ejection of liquid droplets in the driving operation of the recording head.

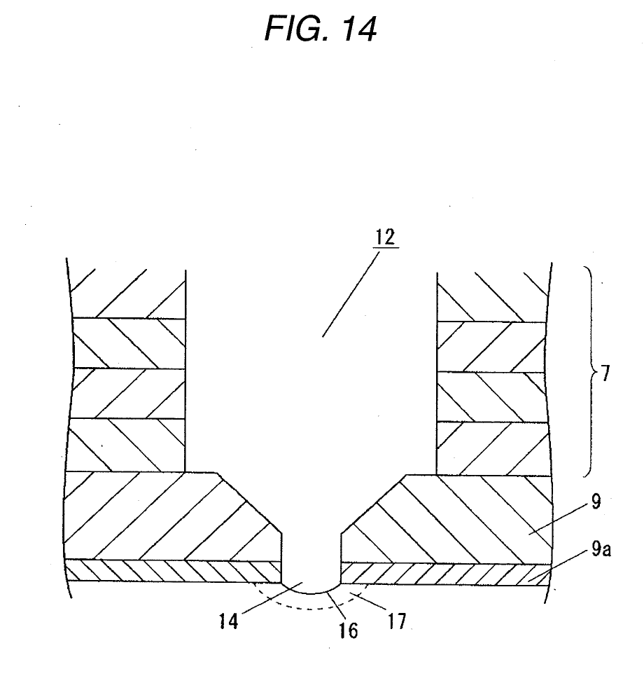

FIG. 14 is a view for explaining a solvent vapor equilibrium layer of a liquid meniscus surface of an opening portion of a nozzle according to the second embodiment of the invention.

As shown in FIG. 14, a liquid meniscus surface 16 is formed in the opening portion of the nozzle of the recording head 1, and a solvent vapor equilibrium layer 17 in which a moisture drying amount and a moisture dissolving amount are set in an equilibrium state over the liquid meniscus surface 16 is formed around the liquid meniscus surface 16.

In FIG. 13, when the vapor content of the liquid solvent vapor in the vicinity of the nozzle is smaller than 5 [g/m³], the solvent vapor equilibrium layer 17 of the liquid meniscus surface 16 shown in FIG. 14 has a small volume, that is, a covering rate of the solvent vapor of the liquid meniscus surface 16 (moisture vapor in the example) is low and the moisture dissolving amount into the recording liquid is insufficient. Therefore, the moisture drying amount is larger than the moisture supplying amount so that the viscosity of the liquid is increased. As a result, an insufficient amount of liquid droplets which are ejected (the state of FIG. 7 described in the first embodiment) and nozzle clogging (the state in FIG. 8) are apt to be caused.

The similar phenomenon is also observed in a recording liquid of an oil type using a drying solvent having a specific gravity ρ, a solvent type or a UV curing type. When the vapor content of the liquid solvent vapor in the vicinity of the nozzle is smaller than 5×ρ [g/m³], the solvent vapor equilibrium layer 17 of the liquid meniscus surface 16 has a small volume and the solvent dissolving amount into the recording liquid is insufficient. Therefore, the solvent drying amount is larger than the solvent supplying amount so that the viscosity of the recording liquid is increased. As a result, the insufficient amount of liquid droplets which are ejected (FIG. 7) and the nozzle clogging (FIG. 8) are apt to be caused in the same manner as described above.

On the other hand, in an oversaturation state in which the vapor content is equal to or larger than a saturated vapor content of the liquid solvent vapor, the solvent vapor is condensed over the nozzle surface to cause flight bending and non-ejection of the liquid droplets, which is not preferable. Actually, in the recording apparatus A using the recording liquid of the water solvent (the specific gravity ρ=1), for example, the liquid droplets are ejected well without causing the flight bending and non-ejection of the liquid droplets in a 25° C. environment at a relative humidity of 99% RH which is lower than the saturated vapor content. In an environment having a relative humidity of 100% RH in which the saturated vapor content is reached, however, the nozzle surface becomes dewy so that the flight bending of the liquid droplets is caused.

FIG. 13 shows the case in which an ejecting environmental temperature is 25° C. At other ejecting environmental temperatures (for example, 0.5° C. to 50° C.), similarly, the vapor content of the liquid solvent vapor in the vicinity of the nozzle which normally ejects the recording liquid is equal to or larger than 5×ρ [g/m³] and a range of less than the saturated vapor content is proper.

It is possible to obtain a saturated vapor content V [g/m³] of water by calculating a saturated vapor pressure E [hPa] at a temperature t ° C. using the following Tetens (Equation 1) and applying the same to (Equation 2) led from an equation of state for the vapor. For example, the saturated vapor content V in a 25° C. environment is obtained as 23 [g/m³], for example.
E=6.11×10ˆ(7.5×t/(t+237.3)) [Equation 1]
V=217×E/(t+273.15) [Equation 2]

In the recording apparatus A using the recording liquid to be the water solvent (the specific gravity ρ=1), accordingly, the effective vapor content of the liquid solvent vapor in the vicinity of the nozzle is equal to or larger than 5 [g/m³] in the 25° C. environment and a range of less than 23 [g/cm³] of the saturated vapor content is proper.

From the results of the investigation, in the second embodiment, the specific gravity ρ of the drying solvent is used as a suitable reference for controlling the driving operation of the solvent vapor control portion 92, and the solvent vapor content detecting portion 91 drives the solvent vapor control portion 92 in the case in which the vapor content of the liquid solvent vapor in the vicinity of the nozzle which is detected is smaller than 5×ρ [g/m³]. When the saturated vapor content or more is reached, the driving operation of the solvent vapor control portion 92 is stopped in order to prevent the unnecessary supply of the solvent vapor.

Although the solvent vapor content detecting portion 91 also has the function of controlling the driving operation of the solvent vapor control portion 92 in the example, it may have such a structure that the control is carried out by the CPU 90 loaded onto the control board 80 as described in the first embodiment, for example. In this case, the solvent vapor content detecting portion 91 has only the function of detecting the vapor content and the solvent vapor control portion 92 carries out a control in such a manner that the vapor content of the liquid solvent vapor in the vicinity of the nozzle is equal to or larger than 5×ρ [g/m³] and is smaller than the saturated vapor content, and the CPU 90 starts to supply the solvent vapor when the vapor content detected by the solvent vapor content detecting portion 91 is smaller than 5×ρ [g/m³], and stops the supply of the solvent vapor when the vapor content detected by the solvent vapor content detecting portion 91 exceeds the saturated vapor content.

As described in the first embodiment, moreover, there are provided temperature detecting portions for detecting a temperature of the nozzle surface and a temperature of the liquid solvent vapor in the vicinity of the nozzle respectively (for example, the nozzle surface temperature detecting portion 82 and the nozzle vicinity air temperature detecting portion 83 shown in FIG. 1), which is not shown in FIG. 12. The solvent vapor control portion 92 may control the temperature of the solvent vapor to be supplied in such a manner that the temperature of the liquid solvent vapor in the vicinity of the nozzle is equal to or lower than the temperature of the nozzle surface based on a temperature detected by each of the temperature detecting portions. By employing the structure, it is possible to prevent the condensation of the solvent vapor over the nozzle surface and to suppress the flight bending and non-ejection of the liquid droplet.

In the second embodiment, furthermore, the solvent vapor collecting portion 53 is disposed in a predetermined position on the ejection side (C side) of the recording medium 41 with respect to the position in which the recording head 1 is to be disposed. The solvent vapor collecting portion 53 efficiently collects the solvent vapor passing through a portion placed just below the nozzle surface and flowing toward the ejection side (C) of the recording medium 41 in the solvent vapor supplied to the nozzle surface by the solvent vapor control portion 92 by a method of sucking the solvent vapor through a sucking system to store the solvent vapor like a gas in a predetermined vessel or a method of liquefying the solvent vapor through cooling and storing the same.

In addition, also in the recording apparatus A according to the second embodiment, there is carried out flushing ejection for flushing the opening portions of the ejecting liquid passage 12 and the nozzle 14 (see FIG. 3 for both of them) in the recording head 1 in the same manner as described in the first embodiment. In this case, since a positional relationship between the nozzle surface and the liquid ejecting portion 52, a duration of the flushing ejection and the number of ejecting times are the same as those in the first embodiment, description will be omitted.

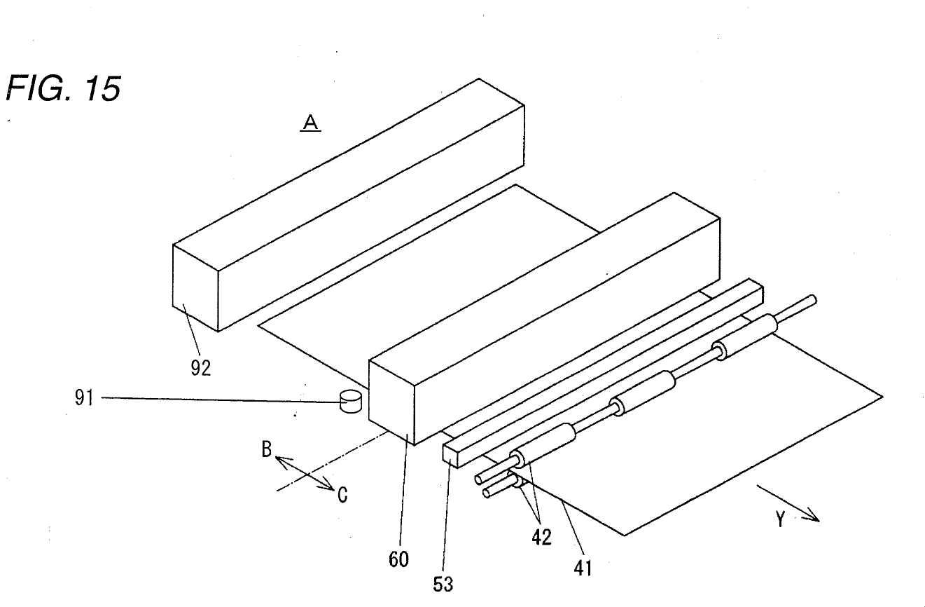

FIG. 15 is a view showing a structure according to a variant of the second embodiment of the invention.

FIG. 15 shows an outer structure of an ink jet recording apparatus comprising a recording head 60 of a line head type in place of the recording head 1 of the serial head type.

In FIG. 15, identical or equivalent components to the components shown in FIG. 12 have the same reference numerals. A portion related to the variant will be mainly described.

As shown in FIG. 15, a recording apparatus A of a line type has such a structure that the liquid ejecting portion 52 is excluded from the structure shown in FIG. 12. The recording head 60 of the line head type is constituted by a plurality of recording heads 1 of the serial head type. Therefore, the description of the first embodiment is exactly applied to the detailed structure of the recording head 60.

The second embodiment is different from the variant in that the recording apparatus A of the line type employs a method of carrying out flushing ejection toward the recording plane of a recording medium 41 while maintaining a recording operation.

According to the second embodiment, therefore, it is possible to produce such an advantage that high speed recording can be carried out without an interruption of a recording operation in addition to the functions and advantages described in the first embodiment.

As described above in detail, the second embodiment includes the following invention.

(1) The ink jet recording apparatus according to the second embodiment has a recording head for ejecting a recording liquid droplet containing a drying solvent from a nozzle to form a dot pattern through the liquid droplet on a recording surface of a recording medium, comprises a solvent vapor control portion provided on a supply side of the recording medium with respect to a position in which the recording head is to be disposed and serving to supply solvent vapor for setting a vapor content of liquid solvent vapor in the vicinity of the nozzle on a nozzle surface of the recording head into a predetermined amount toward a portion between the nozzle surface of the recording head and the recording surface of the recording medium. Also in the case in which various solvents are used as various recording liquids, consequently, it is possible to prevent the liquid from being thickened by drying of the liquid solvent component over a liquid meniscus surface of the opening portion of the nozzle and to effectively prevent an insufficient amount of the liquid droplets which are ejected, nozzle clogging, flight bending and non-ejection from being caused.

(2) In the embodiment, moreover, there is provided a vapor content detecting portion for detecting the vapor content of the liquid solvent vapor in the vicinity of the nozzle over the nozzle surface of the recording head, and the solvent vapor control portion has a control portion for starting to supply the solvent vapor when the vapor content detected by the vapor content detecting portion is smaller than 5×ρ [g/m³] and stops the supply of the solvent vapor when the vapor content detected by the vapor content detecting portion exceeds a saturated vapor content in such a manner that the vapor content of the liquid solvent vapor in the vicinity of the nozzle is equal to or larger than 5×ρ [g/m³] and is smaller than the saturated vapor content, wherein a specific gravity of the drying solvent is set to be ρ.

(3) In the embodiment, furthermore, the ink jet recording apparatus comprises a solvent vapor content detecting portion for stopping a driving operation of the solvent vapor control portion in such a manner that the vapor content of the liquid solvent vapor in the vicinity of the nozzle is equal to or larger than 5×ρ [g/m³] and is smaller than the saturated vapor content, wherein a specific gravity of the drying solvent is set to be ρ. The solvent vapor content detecting portion autonomously drives the solvent vapor control portion. Therefore, a structure of a system can be simplified.

(4) In the embodiment, moreover, the ink jet recording apparatus comprises a temperature detecting portion for detecting a temperature of the nozzle surface of the recording head and a temperature of the liquid solvent vapor in the vicinity of the nozzle respectively, and the solvent vapor control portion controls a temperature of the solvent vapor to be supplied in such a manner that the temperature of the liquid solvent vapor in the vicinity of the nozzle is equal to or lower than the temperature of the nozzle surface based on both of the temperatures which are detected.

(5) In the embodiment, furthermore, the ink jet recording apparatus comprises a solvent vapor collecting portion provided on an ejection side of the recording medium with respect to a position in which the recording head is to be disposed and serving to collect the solvent vapor passing through a portion between the nozzle surface of the recording head and the recording surface of the recording medium. Consequently, it is possible to effectively prevent a dew from being generated in the ink jet recording apparatus. Since the solvent vapor is collected, moreover, it is possible to prevent a situation in which an oil based solvent flows out of the apparatus, for example.

(6) In the embodiment, moreover, a portion for controlling flushing ejection through the recording head is constituted to execute the flushing ejection every predetermined time of 100 sec or less.

(7) In the embodiment, furthermore, when the recording head is of a serial head type, the flushing ejection is carried out toward the liquid ejecting portion disposed in a position placed out of the delivery path for the recording medium in the position in which the recording head is to be provided.

(8) In the embodiment, moreover, when the recording head is of a line head type, the flushing ejection is executed with a recording operation maintained.

(9) In the embodiment, furthermore, the flushing ejection is executed in continuous ejection of one to 1000 shots.

(10) In the embodiment, moreover, the flushing ejection is executed at an equal ejection driving frequency to that in the recording operation.

### Third Embodiment

In the first embodiment, it is possible to enhance a reliability of the ink jet recording apparatus by humidifying the vicinity of the nozzle of the recording head 1 on a predetermined condition. Although the ink meniscus surface can be prevented from being dried by the humidification as described above, the humidification can be effectively taken as a countermeasure against a static electricity.

When the static electricity is stored in a recording medium 41, the ejection of ink droplets is influenced. In the ink jet recording apparatus according to the first embodiment, however, the vicinity of the nozzle is humidified so that the static electricity stored in the recording medium 41 is ejected into the air and is thus removed effectively.

However, in such a print application as to form an image by moving a continuous forms paper at a high speed, for example, as the recording medium 41, the removal of the static electricity by the humidification is limited.

As a countermeasure against the drawback, as is disclosed in JP-A-2003-54069, for example, there has been proposed a recording head for eliminating an electricity from a recording medium by using an antistatic brush in such a manner that a static electricity charging amount has a predetermined value or less and ejecting an ink to the recording medium from which the electricity is eliminated, thereby carrying out a recording operation. With the structure, it is an object to eliminate the electricity from the recording medium, thereby preventing a paper from being contaminated. Depending on a relationship between the recording medium and a charging polarity of an ink droplet, however, there is a possibility that a nozzle surface might be contaminated to cause unsatisfactory ink ejection.

As another countermeasure, as is disclosed in JP-A-2001-199071, for example, there has been proposed a method of adsorbing a paper by an electrostatic force using the paper and adsorbing delivery means and reversing a charging polarity of the charged paper and that of an ink, thereby attracting the ink to form a dot on the paper, resulting in an image. With the structure, however, the ink is separated by an electrostatic force generated by an electric field and an electric charge and is stuck, as an ink droplet, to the paper. For this reason, it is necessary to use a special ink in respect of an ink viscosity and a charging property.

By structures shown in a third embodiment and succeeding embodiments, it is possible to solve the problem for the static electricity. Consequently, it is possible to provide an ink jet recording apparatus capable of considerably reducing an amount of an ink stuck to a nozzle surface and preventing a stability of an image formation from being damaged also in the case in which continuous printing is carried out for a long time.

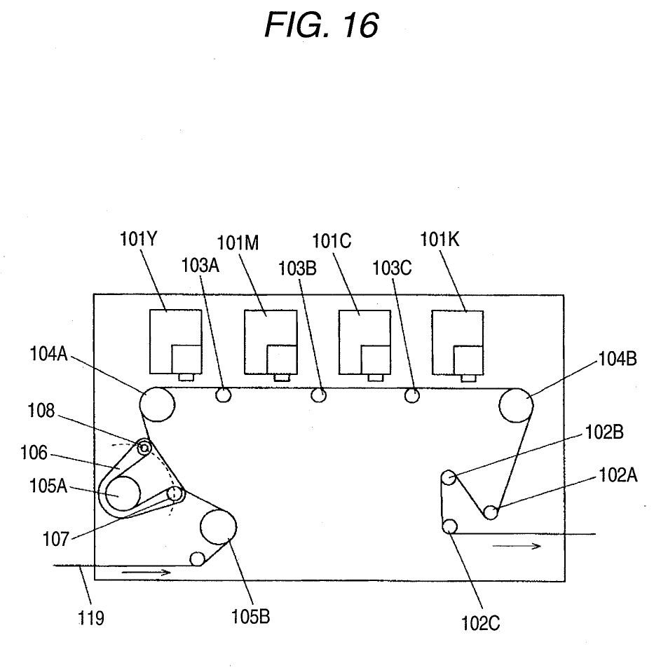

The third embodiment according to the invention will be described below with reference to FIGS. 16 to 22.

FIG. 16 is a typical sectional view showing an ink jet recording apparatus according to the third embodiment of the invention. In FIG. 16, 101Y, 101M, 101C and 101K denote a head box loading a head for ejecting each color ink, 102A, 102B and 102C denote a guide roller on a paper wind-up side, 103A, 103B and 103C denote a positioning roller, and 104A and 104B denote a delivery roller. 105A and 105B denote a friction guide roller, 106 denotes a rotating plate having an equal rotating axis to the friction guide roller 105A, 107 denotes a rotatable tension holding roller having a shaft fixed to the rotating plate 106, 108 denotes a friction tool (a potential control device) attached to the rotating plate 106, and 119 denotes a print paper to be a recording medium to which a predetermined tension is applied from the delivery rollers 104A and 104B and an ink droplet is stuck and which has an image generated on a surface thereof. In the third embodiment, thus, a continuous forms paper is used for the print paper.

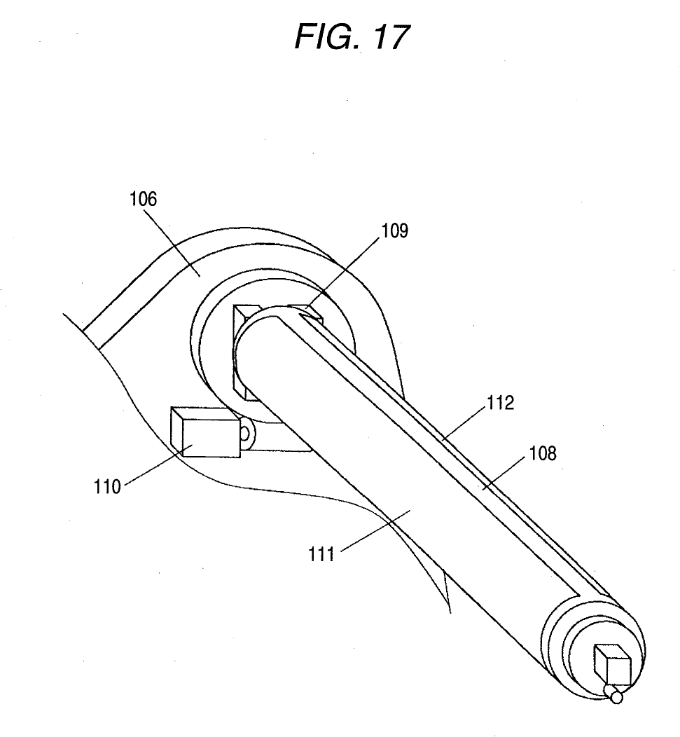

FIG. 17 is an explanatory view showing a state in which a charger according to the third embodiment of the invention is attached.

In FIG. 17, 109 denotes a fixing plate for holding the friction tool 108 through a trench shape, and 110 denotes a rotating mechanism portion for properly applying reverse voltages to change an angle of the fixing plate 109 through a worm gear mechanism. The friction tool 108 takes a cylindrical shape and has a square pole shaft on an axial center at both bottom faces, and is pivotally supported rotatably on the fixing plate 109 through the square pole shaft. A negative electrode member 111 to be a negative side of a charging train which is represented by Teflon® as shown in Table 1 is attached to a side surface of the cylinder over an almost semicircular portion, for example, and a positive electrode member 112 to be a positive side of the charging train which is represented by nylon as shown in Table 1 is attached to the almost residual semicircular portion, for example.

Table 1 shows a list of the charging train for a typical material.

TABLE 1

| | | |
|---|---|---|
| (+ side) | | |
| Asbestos | Aluminum | Vinylon |
| Glass | Zinc | Polystyrene |
| Hair | Cadmium | Orlon |
| Mica | Chromium | Saran |
| Nylon | Paper | Dacron |
| Wool | Ebonite | Dynel |
| Rayon | Hemp | Beron |
| Lead | Iron | Carbide |
| Cotton | Copper | Polyethylene |
| Silk | Nickel | Canecaron |
| Viscose | Brass | Celluloid |
| Human skin | Silver | Cellophane |
| Casein | Sulfur | Vinyl chloride |
| Acetate | Black rubber | Teflon |
| Acryl | Platinum | Cellulose nitrate |
| | | (− side) |

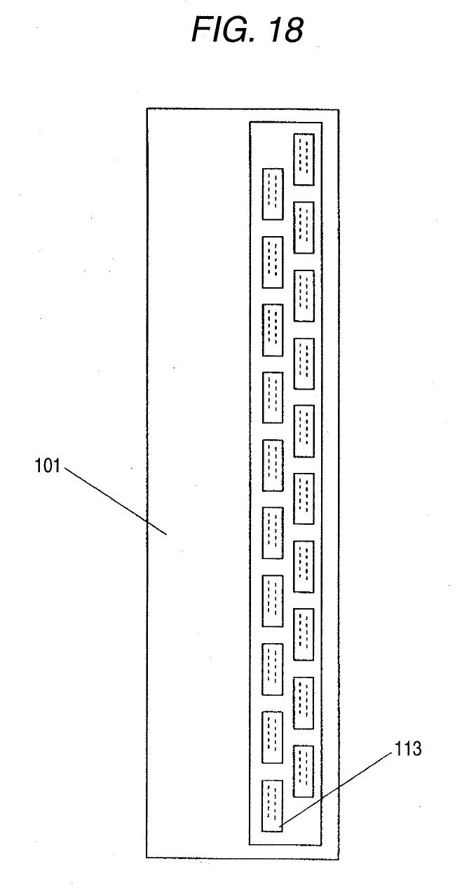

FIG. 18 is a view showing an array of line type heads of the ink jet recording apparatus according to the third embodiment of the invention, illustrating an arrangement seen from a print paper side.

In FIG. 18, 113 denotes a single head. Each head is arranged at an equal interval by a projection of a nozzle hole in a delivery direction of a print paper 119. Although the number of the arranged heads is 20 in FIG. 18, it is apparent that advantages of the embodiment can be obtained even if the number of the arranged heads is optional.

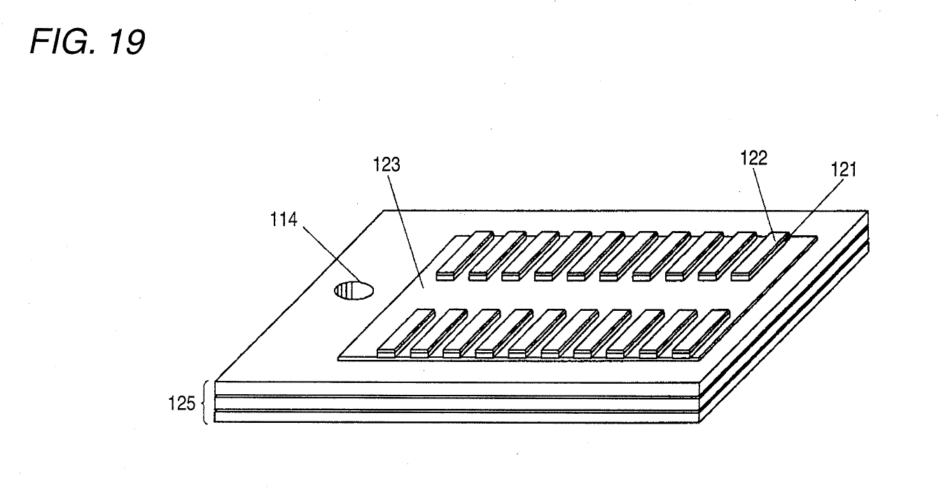

FIG. 19 is a perspective view showing a main part of the single head according to the third embodiment of the invention. In FIG. 19, 121 denotes a piezoelectric element, 122 denotes an upper electrode, 123 denotes a diaphragm (pressure generating means) which also serves as a lower electrode, 125 denotes a passage member constituted by a lamination, and 114 denotes an ink tube connecting hole. The diaphragm 123 serves as a common lower electrode to each piezoelectric element 121. The piezoelectric element 121 and the upper electrode 122 make a pair. Although the number of the piezoelectric elements is 20 in FIG. 19, it is apparent that advantages of the embodiment can be obtained even if the number of the piezoelectric elements is optional.

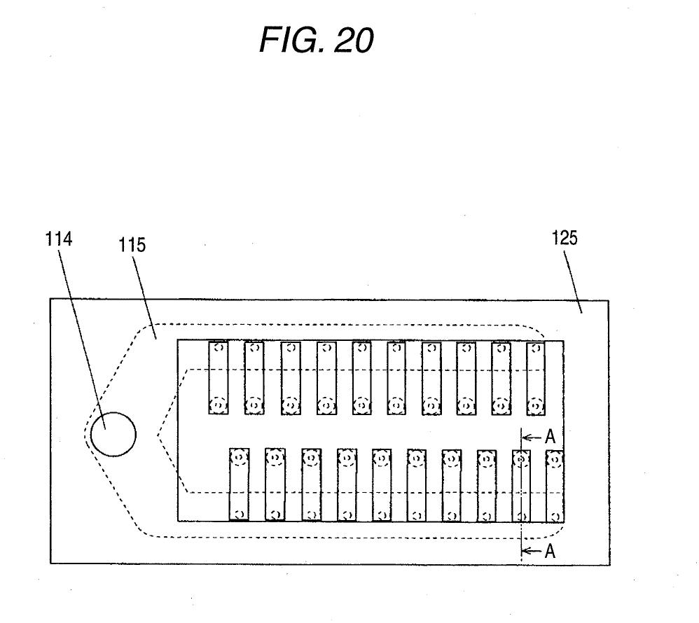

FIG. 20 is a plan view showing a main part of the single head according to the third embodiment of the invention.

In FIG. 20, 115 denotes a common ink passage.

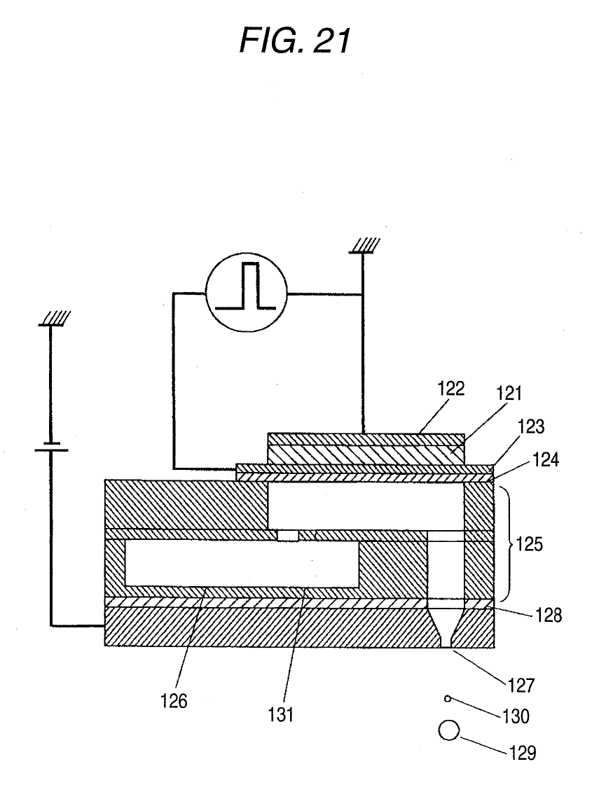

FIG. 21 is a longitudinal sectional view taken along A-A in FIG. 20 according to the third embodiment of the invention, illustrating a structure of a portion corresponding to one nozzle of the pressure generating means for raising an internal pressure of a pressure chamber, a nozzle plate having a plurality of nozzles corresponding to the pressure chamber, and a structure for ejecting an ink droplet on demand from the nozzle at the pressure of the pressure chamber which is raised.

In FIG. 21, 124 denotes an insulating adhesive layer, 131 denotes a pressure chamber provided in the passage member 125 corresponding to the piezoelectric element 121, and 126 denotes a nozzle plate in which a potential is defined to be 35V by a DC power source. A nozzle hole 127 penetrates through the nozzle plate 126 and is tapered at an outlet side in a direction of an ink flow, and is provided corresponding to the pressure chamber 131. 128 denotes an insulating adhesive layer for bonding the passage member 125 to the nozzle plate 126, 129 denotes a main ink droplet ejected from the nozzle hole 127, and 130 denotes a secondary ink droplet separated from the main ink droplet.

The ink jet recording apparatus is roughly classified into a continuous type and an on-demand type. In the continuous type, the ink is always ejected, and a charge is applied if necessary. Consequently, the ink is caused to fly toward the print paper. On the other hand, in the on-demand method, the ink is caused to fly only when printing is to be carried out. The ink jet recording apparatus according to the embodiment is of the on-demand type. However, the ink jet recording apparatus according to the invention is not restricted thereto.

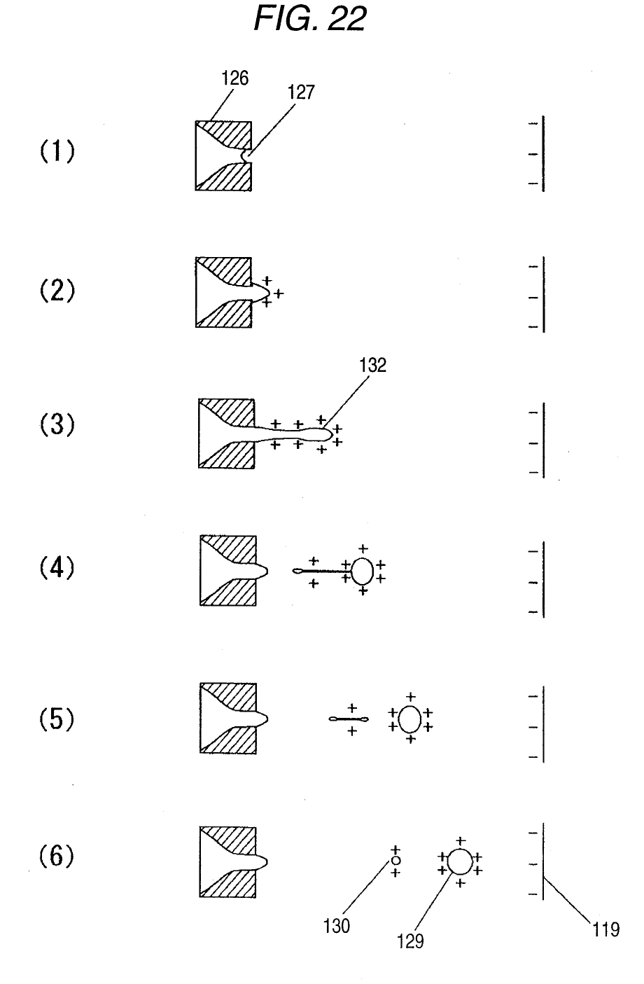

FIG. 22 is a continuously typical sectional view showing an ink droplet ejecting process of the ink jet recording apparatus according to the third embodiment of the invention.

In FIG. 22, 127 denotes a nozzle hole, 132 denotes an ink column, 129 denotes a main ink droplet, and 130 denotes a secondary ink droplet separated from the main ink droplet.

Description will be given to an operation in the ink jet recording apparatus according to the embodiment.

In the case in which a paper is selected as a print recording medium, the friction tool 108 is attached to the fixing plate 109 in such a manner that a frictional surface with the print paper 119 is nylon before the paper is set into the recording apparatus. Next, the rotating plate 106 is laid down and stopped in a proper place in the vicinity of a center of a movable region. The print paper 119 is wound upon each roller in predetermined order to regulate a tension. When a paper delivery instruction is given to the recording apparatus, the delivery rollers 104A and 104B are rotated to deliver the print paper 119 at a predetermined speed and tension. At this time, a friction is generated between the print paper 119 and the positive electrode member 112 provided on the friction tool 108 so that an electrostatic charge is generated by the friction.

As shown in Table 1, in case of the paper and nylon in the charging train, the paper has a negative electrode and the nylon has a positive electrode. Therefore, a negative charge is applied to the print paper 119 so that a surface of the print paper 119 is set to have a negative potential.

In this case, the potential of the print paper 119 is measured on an upstream side in the delivery direction of the head box 101Y by means of a potential measuring tool (not shown), and the friction tool is rotated by the rotating mechanism portion 110 to have a potential of −200 V to −2 kV and an angle at which the rotating plate 106 is to be laid down is thus regulated. In the case in which the potential gets out of the regulating range and does not reach −200 V, a diameter of the friction tool 108 is increased. In the case in which the potential gets out of the regulating range and is lower than −2 kV, the friction tool 108 is rotated by the rotating mechanism portion 110 in such a manner that the nylon and the Teflon® are made frictional with the print paper 119 at the same time, and a surface potential of the print paper 119 is regulated to be approximately −1 kV.

When the regulation is completed, printing can be carried out. When a print instruction is given to the recording apparatus, the delivery rollers 104A and 104B are rotated to deliver the print paper 119 at a predetermined speed and tension. At the same time, the potential of the nozzle plate 126 is fixed to +35 V by a DC power source (not shown). When a paper delivery speed previously reaches a value set by a user, a driving voltage waveform is applied to the diaphragm (lower electrode) 123 by an amplifier (not shown) in a timing depending on a paper delivery speed and a distance in the paper delivery direction of the head box for each color. Then, the upper electrode 122 selected corresponding to a formed image is connected to a GND by a driver (not shown) so that an electric field is applied to the piezoelectric element 121. Consequently, the piezoelectric element 121 is reduced in a planar direction and the diaphragm 123 is bent by a bimetal effect with the diaphragm 123 so that the internal pressure of the pressure chamber 131 is raised. By the internal pressure thus raised, the ink droplets 129 and 130 are ejected from the nozzle hole 127, thereby forming an image on the print paper 119.

FIG. 22 is a view for explaining a behavior of the secondary ink droplet 130 to be an ink mist.

When the internal pressure is transmitted to the nozzle hole set in a standby state as shown in FIG. 22(1), a meniscus is swollen as shown in FIG. 22(2) and an ink column is formed as shown in FIG. 22(3). Since the potential of the nozzle plate is fixed to 35 V, a positive charge is generated on a surface of the ink column.

As shown in FIG. 22(4), subsequently, a constricted part is generated by a surface tension between an ink fed forward by an inertia force and a low-speed ink or an ink returned forcibly and the ink column 132 is cut away so that the main ink droplet 129 is generated. In many cases, the main ink droplet 129 has a thin ink portion like a tail when it is separated from the ink column 132. When the print paper 119 is charged to be negative and the potential is low, there is a tendency that positive and negative charges are generated in the main ink droplet 129 portion and the tail portion by a dielectric polarization, respectively. However, the positive charge is previously applied to the main ink droplet 129. Therefore, great and small positive charges remain in the main ink droplet 129 and the tail portion, respectively.

As shown in FIG. 22(5), then, the tail portion is also cut away by the surface tension to form the secondary ink droplet 130. A small positive charge also remains in the secondary ink droplet 130. For this reason, the secondary ink droplet 130 and the print paper potential suck each other so that the secondary ink droplet 130 is not stuck to the nozzle plate 126 but the print paper 119. At this time, the print paper 119 has a potential difference of 200 V or more for the GND. Also when the print of the fourth head box 101K is ended, therefore, the potential of the print paper 119 is not reduced to 0 V due to a discharge caused by an ink jet or a natural discharge into the air and the secondary ink droplet 130 and the print paper 119 do not repel each other. Moreover, the initial potential of the print paper 119 is set to be equal to or lower than 2 kV. Therefore, it is possible to prevent the main ink droplet 129 from flying due to the generation of a discharge between the nozzle plate 126 and the ink column 132. Thus, an image can be formed stably and continuously.

### Fourth Embodiment

A fourth embodiment according to the invention will be described below with reference to FIGS. 16 to 18 and FIGS. 23 to 26. Since FIGS. 16 to 18 are the same as those in the third embodiment, description will be omitted.

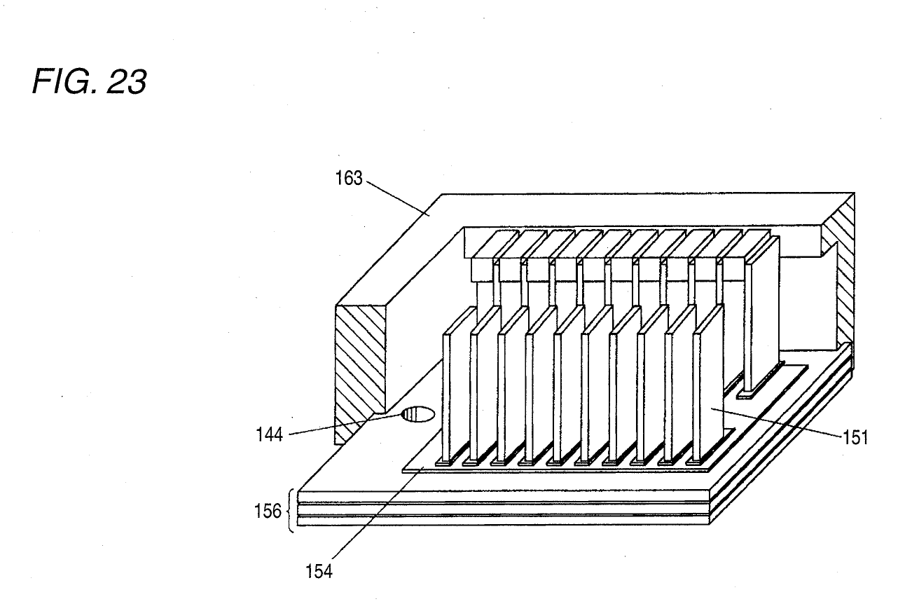

FIG. 23 is a perspective view showing a main part of a single head according to the fourth embodiment of the invention.

In FIG. 23, 151 denotes a piezoelectric element, 154 denotes a diaphragm, 156 denotes a passage member constituted by a lamination, 144 denotes an ink tube connecting hole, and 163 denotes a head base. The diaphragm 154 is common to each of the piezoelectric elements 151. Although the number of the piezoelectric elements 151 in FIG. 23 is 20, it is apparent that advantages of the embodiment can be obtained even if the number of the piezoelectric elements is optional.

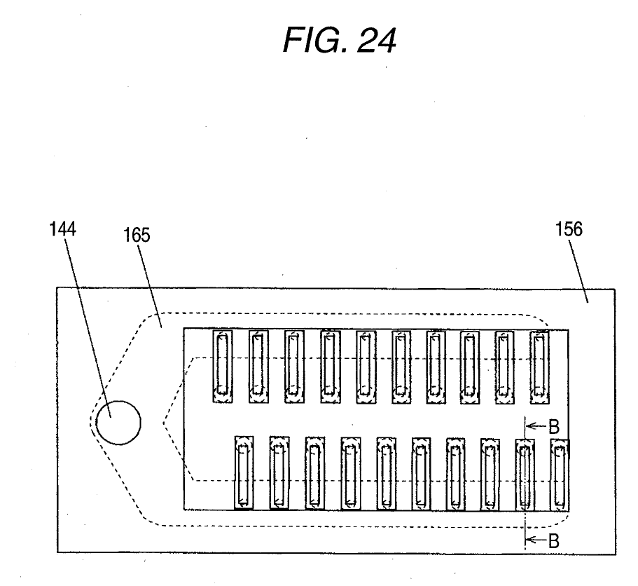

FIG. 24 is a plan view showing the main part of the single head according to the fourth embodiment of the invention.

In FIG. 24, 165 denotes a common ink passage.

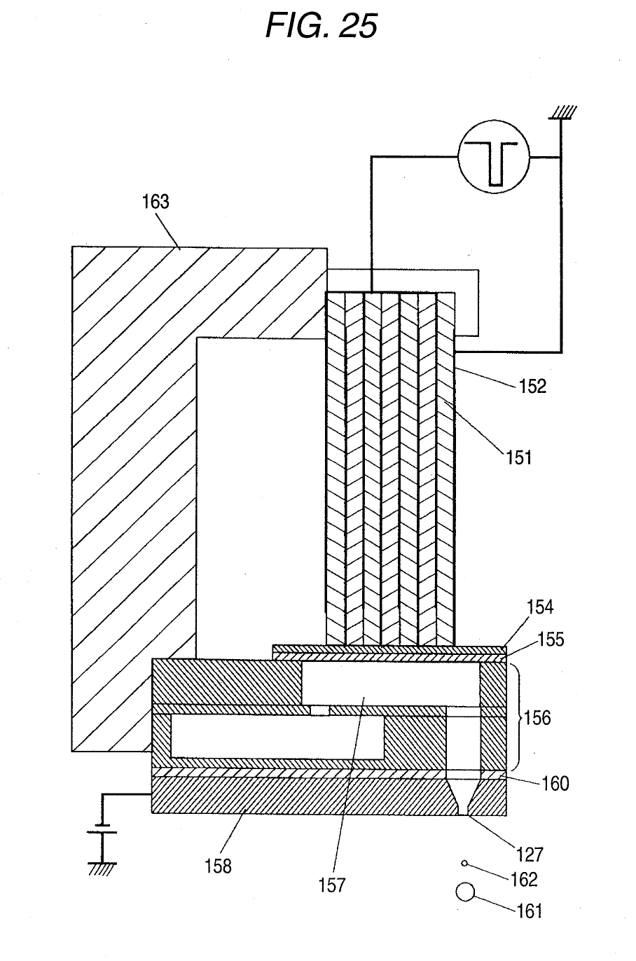

FIG. 25 is a longitudinal sectional view taken along B-B in FIG. 24 according to the fourth embodiment of the invention, illustrating a longitudinal section of a portion corresponding to one nozzle of pressure generating means for raising an internal pressure of a pressure chamber, a nozzle plate having a plurality of nozzles corresponding to the pressure chamber, and a structure for ejecting an ink droplet on demand from the nozzle at the pressure of the pressure chamber which is raised.

In FIG. 25, 151 denotes a piezoelectric element superposed in a multilayer, 152 denotes an upper electrode inserted alternately between the layers of the multilayer piezoelectric element 151, 153 denotes a lower electrode inserted alternately with the upper electrode between the layers of the multilayer piezoelectric element 151, 154 denotes a diaphragm conducted to the lower electrode, 155 denotes an insulating adhesive layer, 156 denotes a passage member, 157 denotes a pressure chamber provided in the passage member 156 corresponding to the piezoelectric element 151, and 158 denotes a nozzle plate in which a potential is defined to −30 V by a DC power source. 159 denotes a nozzle hole which penetrates through the nozzle plate 158, is tapered at an outlet side in a direction of an ink flow and is provided corresponding to the pressure chamber 157. 160 denotes an insulating adhesive layer for bonding the passage member 156 to the nozzle plate 158, 161 denotes a main ink droplet ejected from the nozzle hole 159, and 162 denotes a secondary ink droplet separated from the main ink droplet. The piezoelectric element 151 is fixed to the passage member 156 through the head base 163 and a deforming force which is oriented can be prevented from being gone away.

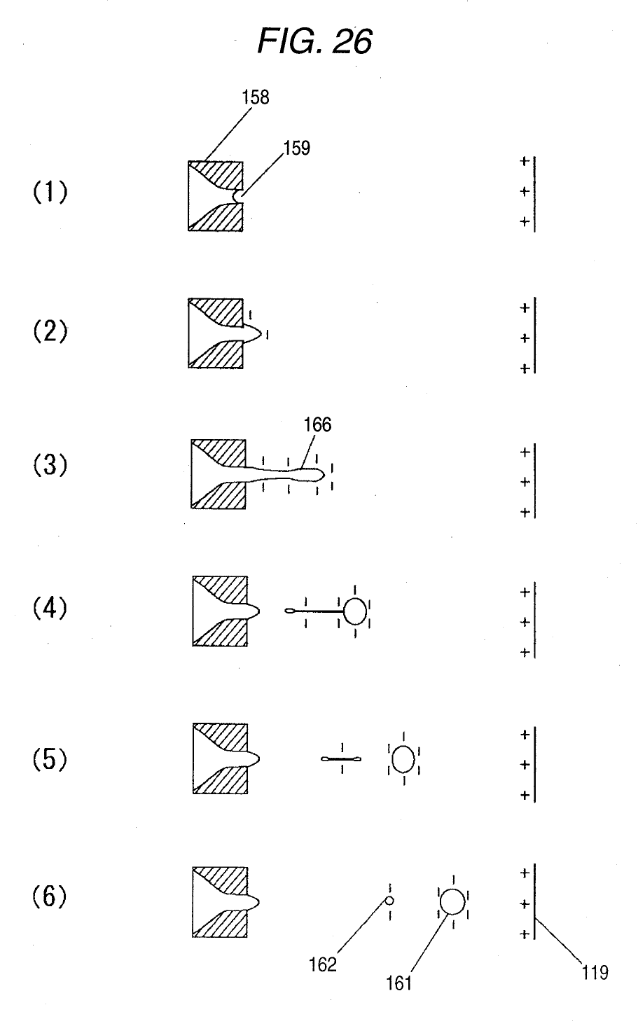

FIG. 26 is a continuously typical sectional view showing an ink droplet ejecting process of the ink jet recording apparatus according to the fourth embodiment of the invention.

In FIG. 26, 159 denotes a nozzle hole, 166 denotes an ink column, 161 denotes a main ink droplet, and 162 denotes a secondary ink droplet separated from the main ink droplet.

Description will be given to an operation in the ink jet recording apparatus according to the embodiment. In the case in which a paper is selected as a print recording medium, a friction tool 108 is attached to a fixing plate 109 in such a manner that a frictional surface with a print paper 119 is Teflon® before the paper is set into the recording apparatus. Next, the rotating plate 106 is laid down and stopped in a proper place in the vicinity of a center of a movable region. The print paper 119 is wound upon each roller in predetermined order to regulate a tension. When a paper delivery instruction is given to the recording apparatus, the delivery rollers 104A and 104B are rotated to deliver the print paper 119 at a predetermined speed and tension. At this time, a friction is generated between the print paper 119 and a negative electrode member 111 provided on the friction tool 108 so that an electrostatic charge is generated by the friction.

As shown in Table 1, in case of a paper and Teflon® in the charging train, the paper has a positive electrode and the Teflon® has a negative electrode. Therefore, a positive charge is applied to the print paper 119 so that a surface of the print paper 119 is set to have a positive potential.

In this case, the potential of the print paper 119 is measured on an upstream side in the delivery direction of the head box 101Y by means of a potential measuring tool (not shown), and an angle at which the rotating plate 106 is to be laid down is regulated to have a potential of +200 V to +2 kV. In the case in which the potential gets out of the regulating range and does not reach +200 V, a diameter of the friction tool 108 is increased. In the case in which the potential gets out of the regulating range and is higher than +2 kV, the friction tool 108 is rotated by the rotating mechanism portion 110 in such a manner that the nylon and the Teflon® are made frictional with the print paper 119 at the same time, and a surface potential of the print paper 119 is regulated to be approximately +1 kV.

When the regulation is completed, printing can be carried out. When a print instruction is given to the recording apparatus, the delivery rollers 104A and 104B are rotated to deliver the print paper 119 at a predetermined speed and tension. At the same time, the potential of the nozzle plate 158 is fixed to −30 V by a DC power source (not shown). When a paper delivery speed previously reaches a value set by a user, a driving voltage waveform is applied to the lower electrode 153 by an amplifier (not shown) in a timing depending on a paper delivery speed and a distance in the paper delivery direction of the head box for each color. Then, the upper electrode 152 selected corresponding to a formed image is connected to a GND by a driver (not shown) so that an electric field is applied to the piezoelectric element 151. The piezoelectric element 151 is oriented in a vertical direction and the diaphragm 154 is pushed downward in a direction of the pressure chamber 157 to raise the internal pressure of the pressure chamber 157. The internal pressure thus raised ejects ink droplets 161 and 162 from the nozzle 159, thereby forming an image on the print paper 119.

FIG. 26 is a continuously typical sectional view showing an ink droplet ejecting process of the ink jet recording apparatus according to the fourth embodiment of the invention.

A behavior of the secondary ink droplet 162 to be an ink mist will be described below with reference to FIG. 26.

When the internal pressure is transmitted to the nozzle hole set in a standby state as shown in FIG. 26(1), a meniscus is swollen as shown in FIG. 26(2) and an ink column 166 is formed as shown in FIG. 26(3). Since the potential of the nozzle plate 158 is fixed to −30 V, a negative charge is generated on a surface of the ink column 166. As shown in FIG. 26(4), subsequently, a constricted part is generated by a surface tension between an ink fed forward by an inertia force and an ink fed at a low speed or an ink returned forcibly and the ink column 166 is cut away so that the main ink droplet 161 is generated. In many cases, the main ink droplet 161 has a thin ink portion like a tail when it is separated from the ink column 166. When the print paper 119 is charged to be positive and the potential is high, there is a tendency that negative and positive charges are generated in the main ink droplet 161 portion and the tail portion by a dielectric polarization, respectively. However, the negative charge is previously applied to the ink droplet. Therefore, great and small negative charges remain in the main ink droplet 161 and the tail portion, respectively.

As shown in FIG. 26(5), then, the tail portion is also cut away by the surface tension to form the secondary ink droplet 162. A small negative charge also remains in the secondary ink droplet 162 and the secondary ink droplet 162 and the print paper potential suck each other. For this reason, the secondary ink droplet 162 is not stuck to the nozzle plate 158 but the print paper 119. At this time, the print paper 119 has a potential difference of 200 V or more for the GND. Also when the print of the fourth head box 101K is ended, therefore, the potential of the print paper 119 is not reduced to 0 V due to a discharge caused by an ink jet or a natural discharge into the air and the secondary ink droplet 162 and the print paper 119 do not repel each other. Moreover, the potential of the print paper 119 is set to be equal to or lower than 2 kV. Therefore, it is possible to prevent the main ink droplet 161 from flying due to the generation of a discharge between the nozzle plate 158 and the ink column 166. Thus, an image can be formed stably and continuously.

### Fifth Embodiment

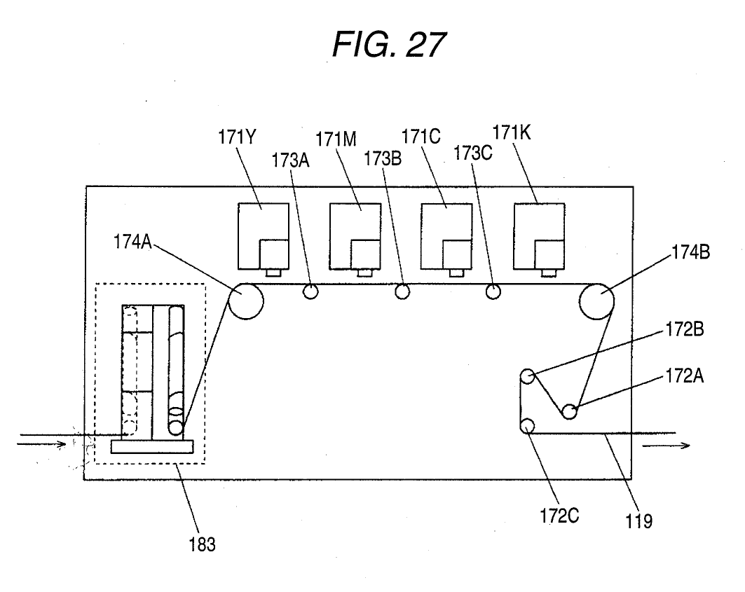

FIG. 27 is a typical sectional view showing an ink jet recording apparatus according to a fifth embodiment of the invention.

The fifth embodiment according to the invention will be described below with reference to FIGS. 18 to 21, 27, 28 and 29.

In FIG. 27, 171Y, 171M, 171C and 171K denote a head box loading a head for ejecting each color ink, 172A, 172B and 172c denote a guide roller on a paper wind-up side, 173A, 173B and 173C denote a positioning roller, 174A and 174B denote a delivery roller, and 183 denotes a recording medium charger (a potential control device) serving as a print paper inverting unit.

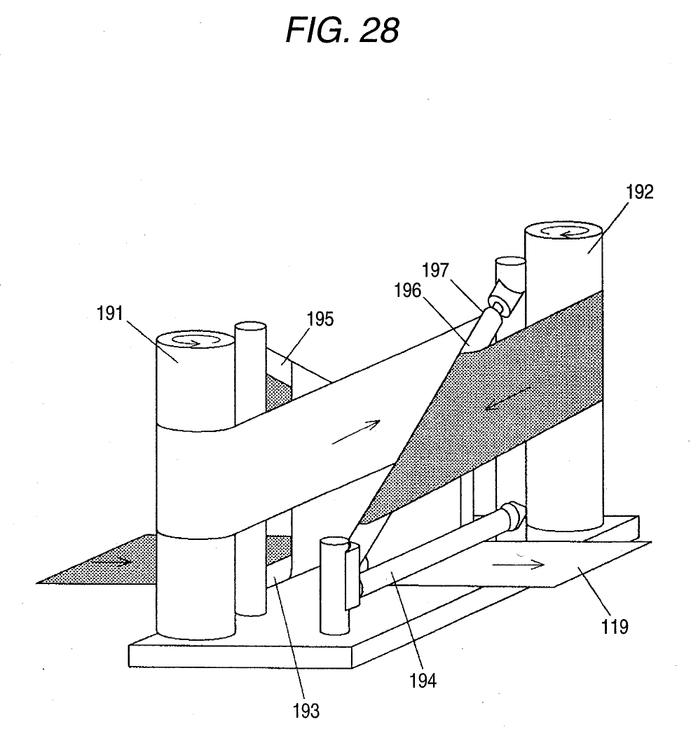

FIG. 28 is a perspective view showing a main part of the recording medium charger according to the fifth embodiment of the invention.

In FIG. 28, 191 denotes a wind-up side longitudinal roller, 192 denotes a feeding side longitudinal roller for regulating a tension of the print paper together with the wind-up side longitudinal roller 191, 193 and 194 denote a guide roller, 195 denotes an oblique roller attached at an angle of 45 degrees with respect to a print plane, and 196 denotes a frictional charging roller. The frictional charging roller 196 is attached at an angle of 45 degrees with respect to a print plane and an angle of 90 degrees with respect to the oblique roller 195, takes a cylindrical shape and is rotatable with a centerline set to be a rotating axis, and an acrylic positive electrode member 197 is attached to a side surface part of a rotating roller portion.

FIGS. 18 and 19 are the same as the third embodiment and description will be omitted.

In the ink jet recording apparatus according to the embodiment, the operation will be described below.

In the case in which a paper is selected as a print recording medium, the frictional charging roller 196 having the acrylic positive electrode member 197 is attached to a frictional surface with the print paper 119 before the paper is set onto the recording apparatus. Next, the print paper 119 is wound upon the respective rollers in predetermined order to regulate a tension. The print paper 119 enters, at an angle of 45 degrees, two rollers attached at angles of 45 degrees and 135 degrees as shown in FIG. 28, and gets out at 135 degrees. As a result, the print paper 119 is twisted at 180 degrees so that both sides of the print surface are inverted. In FIG. 28, either side of the print paper 119 is shown in hatching to enhance a visibility, thereby contributing to explanation.

When a paper delivery instruction is given to the recording apparatus, the delivery rollers 174A and 174B are rotated so that the print paper 119 is delivered at a predetermined speed. The delivery rollers 174A and 174B and the wind-up side longitudinal roller 191 and the feeding side longitudinal roller 192 in the charging device 183 are interlocked with each other to regulate the tension of the print paper 119.

The print paper 119 is wound upon the frictional charging roller 196 at an angle of 45 degrees with respect to a central axis of the frictional charging roller 196, and the frictional charging roller 196 is rotatable around a central axis. Therefore, a friction is not generated in a circumferential direction of the frictional charging roller 196, and the friction between the positive electrode member 197 and the print paper 119 is generated in only a parallel direction with the central axis of the frictional charging roller 196. An electrostatic charge is generated by the friction.

In the charging train shown in Table 1, in case of a paper and acryl, the paper has a negative electrode and the acryl has a positive electrode. Therefore, a negative charge is applied to the print paper 119 so that a surface of the print paper 119 is set to have a negative potential. In this case, the potential of the print paper 119 is measured on an upstream side in the delivery direction of the head box 171Y by using a potential measuring apparatus (not shown). When the potential does not reach −200 V, a material of the positive electrode member 197 is exchanged with a material which is positioned at a longer distance over the charging train, for example, nylon. In the case in which the potential is lower than −2 kV, the material of the positive electrode member 197 is exchanged for a material positioned closer over the charging train, for example, aluminum and a surface potential of the print paper 119 is regulated to be approximately −1 kV. As a matter of course, it is apparent that the potential of the print paper can be regulated in a combination with the third and fourth embodiments.

When the regulation is completed, the print can be carried out. When a print instruction is given to the recording apparatus, the delivery rollers 174A and 174B are rotated to deliver the print paper 119 at a predetermined speed. The delivery rollers 174A and 174B and the wind-up side longitudinal roller 191 and the feeding side longitudinal roller 192 in the charging device 183 are interlocked with each other to regulate the tension of the print paper 119.

At the same time, the potential of the nozzle plate 126 is fixed to +35 V by a DC power source (not shown). When a paper delivery speed previously reaches a value set by a user, a driving voltage waveform is applied to the lower electrode 123 by an amplifier (not shown) in a timing depending on the paper delivery speed and a distance in the paper delivery direction of the head box for each color. Then, the upper electrode 122 selected corresponding to a formed image is connected to a GND by a driver (not shown) so that an electric field is applied to the piezoelectric element 121. The piezoelectric element 121 is reduced in a planar direction, the diaphragm 123 is bent by a bimetal effect with the diaphragm 123, the internal pressure of the pressure chamber 131 is raised, and the internal pressure thus raised ejects the ink droplets 129 and 130 from the nozzle hole 127 to form an image on the print paper 119.

Since a behavior of the secondary ink droplet 130 to be an ink mist at this time is the same as that in the third embodiment, description will be omitted.

### Sixth Embodiment

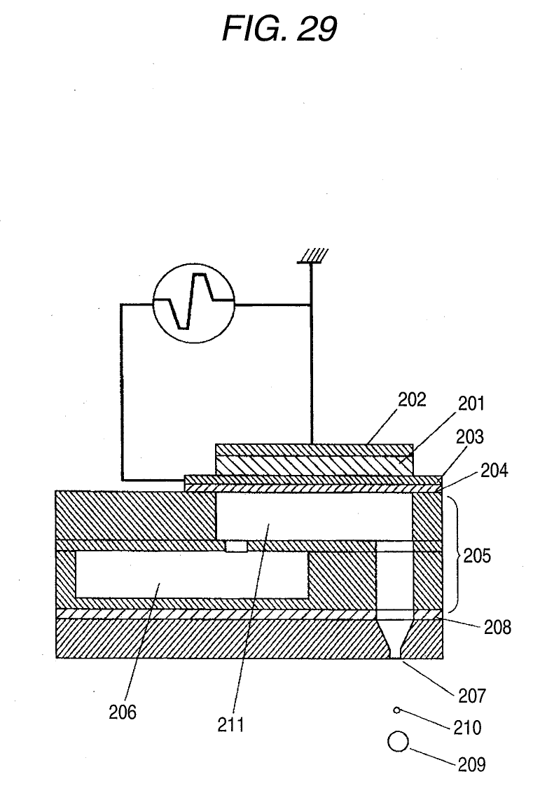

A sixth embodiment according to the invention will be described below with reference to FIGS. 29, 30 and 31.

FIG. 29 is a longitudinal sectional view showing a main part of a single head according to the sixth embodiment of the invention.

In FIG. 29, 201 denotes a piezoelectric element, 202 denotes an upper electrode, 203 denotes a diaphragm serving as a lower electrode which is common to a plurality of piezoelectric elements. 204 denotes a conductive adhesive layer, 205 denotes a passage member formed by a stainless material, 211 denotes a pressure chamber provided in the passage member 205 corresponding to the piezoelectric element 201, 206 denotes a nozzle plate, and 207 denotes a nozzle hole which penetrates through the nozzle plate 206, is tapered at an outlet side in a direction of an ink flow and is provided corresponding to the pressure chamber. 208 denotes a conductive adhesive layer for bonding the passage member 205 to the nozzle plate 206, 209 denotes a main ink droplet ejected from the nozzle hole 207, and 210 denotes a secondary ink droplet separated from the main ink droplet.

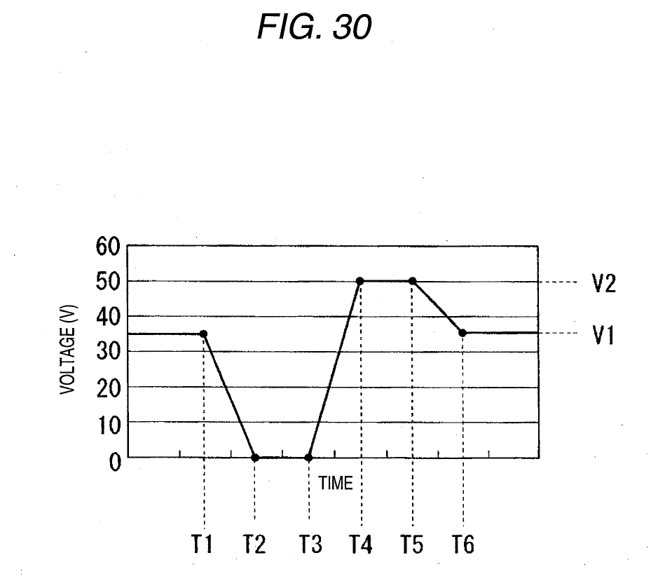

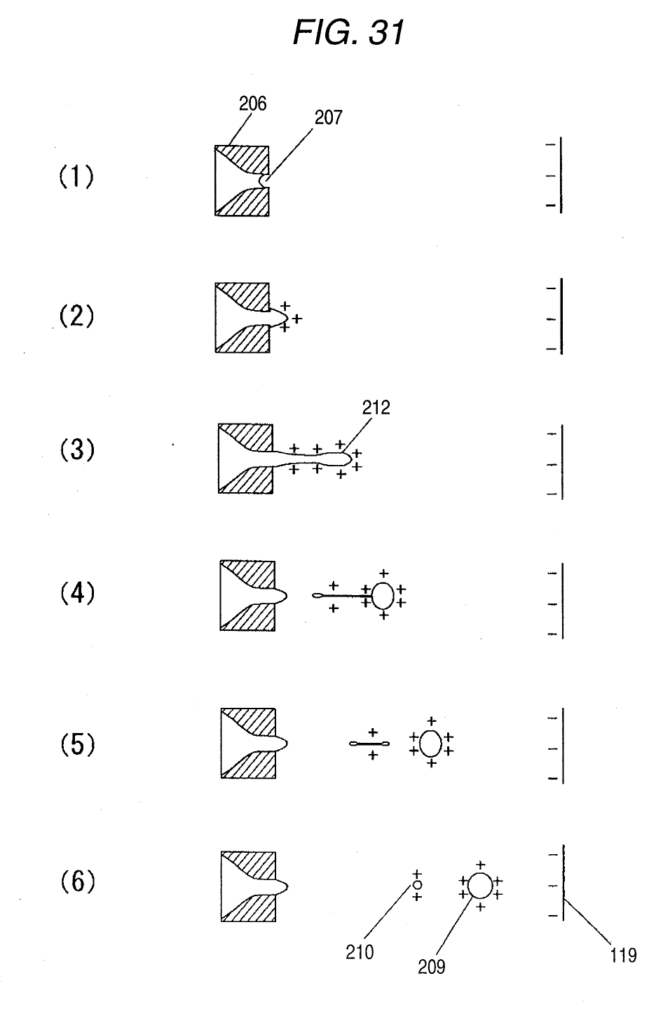

A behavior of the secondary ink droplet 210 to be an ink mist at this time will be described with reference to FIGS. 30 and 31.

FIG. 30 is a voltage waveform diagram for the ink jet recording apparatus according to the sixth embodiment of the invention.

In FIG. 30, a voltage waveform of “pull”-“push”-“pull” is applied to the piezoelectric element 201 between the diaphragm 203 and the upper electrode 202. Since the diaphragm 203 is a common electrode, an ink in the vicinity of all of the nozzles has the same potential. Symbols T1 to T6 are given corresponding to a timing of the voltage waveform, and potentials of the voltage waveform are indicated as V1 and V2.

FIG. 31 is a continuously typical sectional view showing an ink droplet ejecting process of the ink jet recording apparatus according to the sixth embodiment of the invention.

In FIG. 31, 206 denotes a nozzle hole, 212 denotes an ink column, 209 denotes a main ink droplet, 210 denotes a secondary ink droplet separated from the main ink droplet, and 119 denotes a print paper in which a negative charge is previously applied to a surface and a negative potential of −200 V to −2 kV is generated.

Description will be given to an operation in the ink jet recording apparatus according to the embodiment. As shown in FIG. 30, an applied voltage is held in a state of V1 in a section from a standby state to T1. Therefore, the piezoelectric element 201 is reduced in a planar direction and the diaphragm 203 is bent by a bimetal effect with the diaphragm 203 and a volume of the pressure chamber 211 is held in a decreasing state.

In a section from T1 to T2, next, a gradual decrease from the applied voltage V1 to GND is carried out. Therefore, the bimetal effect is reduced so that the pressure chamber 211 is gradually enlarged. At this time, a meniscus of the nozzle hole 207 is slightly retracted like a concave portion as shown in FIG. 31(1).

Subsequently, the voltage is held in a section from T2 to T3, and the applied voltage is then raised from GND to V2 in a section from T3 to T4 to further decrease the volume of the pressure chamber 211 as compared with that in the standby state. At this time, the meniscus is bulged as shown in FIG. 31(2) and the ink column 212 is formed as shown in FIG. 31(3). The nozzle plate 206 is electrically conducted to the diaphragm 203 and the conductive adhesive layers 204 and 208 through the passage member 205. Therefore, the potential of the nozzle plate 206 is equal to that of the diaphragm 203 and a positive charge is generated on a surface of the ink column 212.

Next, the voltage is held in a section from T4 to T5 and the applied voltage is gradually dropped from V2 to V1 in a section from T5 to T6 to increase the voltage of the pressure chamber 211 and to recover the standby state. At this time, as shown in FIG. 31(4), a constricted portion is generated by a surface tension between an ink fed forward by an inertia force and an ink fed at a low speed or an ink returned forcibly, and the ink column 212 is cut away so that the main ink droplet 209 is generated. Since the potential of the nozzle plate 206 is held to be V1, however, the main ink droplet 209 has a positive charge. In many cases, the main ink droplet 209 has a thin ink portion taking a shape of a tail in a separation from the ink column 212. There is a tendency that positive and negative charges are generated in the main ink droplet 209 portion and the tail portion by a dielectric polarization respectively when the print paper 119 is charged to be negative and has a low potential. However, the main ink droplet 209 previously has the positive charge. Therefore, large and small positive charges remain in the main ink droplet 209 and the tail portion, respectively.

As shown in FIG. 31(5), then, the tail portion is also cut away by the surface tension so that the secondary ink droplet 210 is generated. As a result, the small positive charge also remains in the secondary ink droplet 210, and the small positive charge and the potential of the print paper suck each other. Therefore, the secondary ink droplet 210 is not stuck to the nozzle plate 206 but print paper 119. At this time, the potential of the print paper is negative by −200 V or more with respect to GND. Therefore, the charge can be prevented from being suddenly gone due to a discharge caused by an ink jet or a natural discharge. Since the potential of the print paper 119 is set to be a negative potential which is lower than −2 kV, moreover, the discharge is prevented from being generated together with the nozzle surface and the discharge is prevented from being generated between the print paper 119 and the nozzle plate 206 or the ink column 211 to scatter the main ink droplet 209 so that an image can be formed stably and continuously.

Moreover, the nozzle plate 206 and the diaphragm 203 are electrically conducted to each other. Therefore, a current does not flow between the nozzle plate 206 and the diaphragm 203. Accordingly, minute bubbles generated by an electrolysis do not stay in the pressure chamber. Thus, a stable printing operation can be implemented. While the description has been given to the combination in which the voltage waveform is on the positive electrode side and the potential of the print paper 119 is on the negative electrode side in the sixth embodiment, it is apparent that the same functions can be obtained in a combination in which the voltage waveform is on the negative electrode side and the potential of the print paper 119 is on the positive electrode side.

Moreover, it is a matter of course that the sixth embodiment can be carried out simultaneously with the third and fifth embodiments, and furthermore, the fourth and fifth embodiments.

### EXAMPLE

Specific contents of the invention will be described below with reference to an example.

### Example 1

Table 2 shows a dependency of a potential after printing on an initial potential and a relative humidity in the formation of an image on a print paper.

TABLE 2

| | Initial potential V | | | | | |
|---|---|---|---|---|---|---|
| | 200 | 500 | 1000 | 2000 | 2500 | 3000 |
| RH80% | 3 | 282 | 763 | 1550 | 1980 | Discharge |
| RH20% | 35 | 301 | 783 | 1650 | Discharge | Discharge |

A plain paper (OKH-J OFF 70 produced by Oji Paper Co., Ltd.) is used for the print paper. For a printing condition, moreover, an environmental temperature is set to be 30° C., a printing speed is set to be 60 m/minute, and a relative humidity is set to be 20% RH and 80% RH.

As shown in Table 2, it is apparent that the discharge is not carried out with an initial potential of 2 kV or less in 20% RH and a potential is not dropped to a GND level with an initial potential of 200 V or higher in 80% RH, and the advantages of the invention can be obtained.

Since the ink jet recording apparatus described above can be operated continuously for a long time, it can be suitably utilized in a paper printing field for a newspaper print and a direct mail, a resin printing field for a label of a PET bottle and a DVD, a cloth printing field for textile printing, and a panel printing field for an external wall.

As described above in detail, the third to sixth embodiments have the following invention.

(1) The ink jet recording apparatus described in the third embodiment and thereafter comprises a plurality of pressure chambers, pressure generating means for raising an internal pressure of the pressure chamber, and a nozzle plate provided for each of the pressure chambers, having a plurality of nozzles and serving to ejection an ink droplet from the nozzle at a pressure of the pressure chamber, thereby forming a dot on a recording medium, and a potential control device for controlling a potential of the nozzle plate in such a manner that the recording medium has a potential. By the structure, the ink droplet ejected from the nozzle is not returned to the nozzle plate but is stuck to the recording medium, and an amount of the ink stuck to the nozzle surface can be reduced considerably. Also in the case in which continuous printing is carried out for a long time, a stability of an image formation can be prevented from being damaged.

(2) In the embodiment, moreover, the potential control device is set to be a friction tool for giving a charge to the recording medium by generating a friction between a member having a different charging train from the recording medium and the recording medium. By the structure, the member is selected in consideration of the charging train of the recording medium. Therefore, the potential can be freely set to be a positive electrode and a negative electrode, and furthermore, the friction is used. Consequently, there is a function capable of changing a charging amount corresponding to a recording medium delivery speed.

(3) In the embodiment, moreover, the friction tool is constituted by a positive side member in the charging train of the recording medium, and a friction is generated between the positive side member and the recording medium to apply a negative charge to the recording medium. By the structure, there is a function capable of generating a stable negative charge on the recording medium and setting the recording medium to have a negative potential by generating a friction in a delivery direction between the friction tool having a member on the positive electrode side from the charging train of the recording medium and a contact surface of the recording medium.

(4) In the embodiment, furthermore, the friction tool is constituted by a negative side member in the charging train of the recording medium, and a friction is generated between the negative side member and the recording medium to apply a positive charge to the recording medium. By the structure, there is a function capable of generating a stable positive charge on the recording medium and setting the recording medium to have a positive potential by generating a friction in the delivery direction between the friction tool having a member on the negative electrode side from the charging train of the recording medium and the contact surface of the recording medium.

(5) In the embodiment, moreover, the friction tool takes an almost cylindrical shape and comes in contact with the recording medium on a side surface of the cylindrical shape, and furthermore, the potential control device changes a contact portion area of the cylindrical shape, thereby controlling an amount of charges of the recording medium. By the structure, it is possible to regulate the amount of the charges on the recording medium by coming in contact with the recording medium on the side surface of the cylindrical shape and controlling the amount of the charges in an area of the contact portion. Even if order in the charging train is not close, a desirable potential can be obtained. Therefore, there is a function capable of decreasing the types of members to be provided on the surface of the friction tool and reducing a cost.

(6) In the embodiment, furthermore, the friction tool has a side surface provided with at least two types of members having different charging trains, and controls the charging amount by increasing or decreasing a ratio of a contact area of the two types of members. By the structure, there is a function capable of easily changing only a potential to be changed without varying a tension of a print paper.

(7) In the embodiment, moreover, the friction tool generates a friction between the member having the different charging train from the recording medium and the recording medium in such a manner that a direction of the friction has a component in a transverse direction of the recording medium. By the structure, the friction is generated in the transverse direction in addition to the delivery direction of the recording medium. Consequently, there is a function capable of increasing a contact length and efficiently generating the friction.

(8) In the embodiment, furthermore, the friction tool has a friction component in the transverse direction of the recording medium by a friction in a parallel direction with a central axis of a surface of a roller which can be rotated with respect to the central axis. By the structure, the roller is rotated by the delivery of the recording medium and a portion for generating a friction with the recording medium is replaced. Therefore, there is a function capable of preventing a biased wear of the friction member on the surface of the roller and prolonging a time taken before an exchange of the friction member, that is, a lifetime of a component.

(9) In the embodiment, moreover, a predetermined friction tool is selected based on the type, speed, humidity and temperature of the recording medium, and the friction tool can be attached to and removed from the apparatus. By the structure, in the case in which the amount of generated charges does not have a desirable value due to a change in an environment, it is possible to easily take a countermeasure by newly using a friction tool in which the contact area with the member having the different charging train and the recording medium is varied.

(10) In the embodiment, furthermore, the potential control device carries out a control for causing the potential of the recording medium to have a reverse polarity to the polarity of the charge of the ink droplet. By the structure, there is a function in which an electrostatic attraction is generated between the ejected ink droplet and the recording medium and the ink droplet is not returned to the nozzle plate but is stuck to the recording medium and can form a dot.

(11) In the embodiment, moreover, the pressure generating means raises the pressure in the pressure chamber by a displacement of a vibrating member forming at least one surface of the pressure chamber. By the structure, there is a function in which a shape of the ink droplet to be generated and an ejection timing are stable and a reproducibility of the potential to be applied to the ink droplet is high.

(12) In the embodiment, furthermore, the potential control device defines the potential of the nozzle plate, thereby defining the polarity of the charge of the ink droplet. By the structure, the charge does not stay in the nozzle plate but the potential is stable even if a continuous printing operation is carried out. Therefore, there is a function in which the potential of the ink droplet ejected into the air is stable and the ink droplet can be stably stuck to the recording medium.

(13) In the embodiment, moreover, the ink droplet generated from the nozzle at the pressure of the pressure chamber includes a main ink droplet constituting most of dots to be formed on the recording medium and at least one secondary ink droplet constituting the residual parts of the dot. By the structure, even if the condition of the ejecting system is changed with a variation in a viscosity of the ink depending on a temperature, the number and size of the secondary ink droplets is simply changed slightly. Therefore, there is a function in which a redundancy of the ejecting system for a change in a temperature is increased so that a dot can be stably formed on the recording medium.

(14) In the embodiment, furthermore, the potential of the recording medium is set to be higher than that of the nozzle and the potential difference between the potential of the recording medium and that of the nozzle is 200 V to 2 kV when the potential of the nozzle has a negative polarity, and is set to be lower than the potential of the nozzle and the potential difference between the potential of the recording medium and that of the nozzle is 200 V to 2 kV when the potential of the nozzle has a positive polarity. By the structure, an ink mist is stuck to the recording medium by an electrostatic force and is not returned to the nozzle plate, and a discharge is not generated between the recording medium and the nozzle plate or meniscus. Therefore, there is a function capable of forming a desirable image with a stability of the ink droplet maintained.

(15) Moreover, the ink jet recording apparatus according to the embodiment comprises a plurality of pressure chambers, pressure generating means for raising an internal pressure of the pressure chamber, and a nozzle plate provided for each of the pressure chambers and having a plurality of nozzles, and serving to ejection an ink droplet from the nozzle at the pressure of the pressure chamber, thereby forming a dot on the recording medium, and the pressure chamber has a vibrating member for forming at least one surface, a piezoelectric element provided in the pressure chamber, a first electrode provided on an optional surface of the piezoelectric element, and a second electrode provided on a surface at an opposite side of the first electrode of the piezoelectric element, and a potential of the first electrode is controlled to change a shape of the piezoelectric element, thereby raising the pressure in the pressure chamber to ejection an ink droplet from the nozzle, and the first electrode and the vibrating member are electrically conducted to each other, and furthermore, the nozzle plate and the vibrating member are electrically conducted to each other to cause the first electrode, the vibrating member and the nozzle plate to have an equal potential.

By the structure, the potential of the ink in the pressure chamber can be set to be equal to the potential of the nozzle. Therefore, the potential of the ink reaching the nozzle plate can be stably set to have a desirable value. In addition, an electricity does not flow through the ink between the diaphragm and the nozzle plate. Therefore, there is a function in which the generation and stay of minute bubbles through an electrolysis can be prevented from being caused in the pressure chamber and the ink can be stably ejected.

(16) In the embodiment, furthermore, the potential of the recording medium has a polarity which is opposite to the polarity of the potential of the nozzle plate when the ink droplet is separated from the nozzle plate. Even if a voltage applied to the piezoelectric element in a discharge is changed from a positive voltage to a negative voltage, the potential of the recording medium is determined corresponding to the potential of the nozzle plate in the separation of the ink droplet from the nozzle plate. Therefore, there is a function in which an ink mist is reliably stuck to the recording medium and is not returned to the nozzle plate.

(17) In the embodiment, furthermore, the potential of the recording medium is set to be higher than that of the nozzle and the potential difference between the potential of the recording medium and that of the nozzle is 200 V to 2 kV when the potential of the nozzle has a negative polarity, and is set to be lower than the potential of the nozzle and the potential difference between the potential of the recording medium and that of the nozzle is 200 V to 2 kV when the potential of the nozzle has a positive polarity. By the structure, the ink droplet is stuck to the recording medium by an electrostatic force and is not returned to the nozzle plate, and a discharge is not generated between the recording medium and the nozzle plate or meniscus. Therefore, there is a function in which the ink droplet is stably ejected so that a desirable image can be formed.

As described above, the ink jet recording apparatus according to the invention is useful for stably forming a liquid meniscus in an opening portion of a nozzle to effectively prevent an insufficiency of the amount of a droplet to be ejected from the nozzle and nozzle clogging without being conscious of a driving timing of the ink jet recording apparatus irrespective of a type of a drying solvent of a recording liquid to be used, and particularly, is suitably utilized in a wide field such as household and industrial ink jet recording apparatuses, printing machines and copying machines, and substrate wiring pattern drawing apparatuses.

The present application is based upon and claims the benefit of priority of Japanese Patent Applications No. 2006-160492 filed on Jun. 6, 2006, No. 2006-164307 filed on Jun. 14, 2006 and No. 2006-216889 filed on Aug. 9, 2006, the entire contents of which are incorporated herein by reference.

What is claimed is:

1. An ink jet recording apparatus comprising:
a recording head for ejecting a liquid droplet from a nozzle based on an ejecting signal to form a pattern on a recording medium;
a humidity detecting portion for detecting an absolute humidity in a vicinity of the nozzle;
a humidifying portion for humidifying the vicinity of the nozzle; and
a humidifying portion driving control portion for controlling the humidifying portion based on the absolute humidity detected by the humidity detecting portion.

2. An ink jet recording apparatus comprising:
a recording head for ejecting a liquid droplet from a nozzle based on an ejecting signal to form a pattern on a recording medium;
a humidity detecting portion for detecting an absolute humidity and a relative humidity of air in a vicinity of the nozzle;
a humidifying portion for supplying humidified air to the vicinity of the nozzle; and
a humidifying portion driving control portion for controlling a driving operation of the humidifying portion such that the absolute humidity of the air in the vicinity of the nozzle which is obtained by the humidity detecting portion is equal to or higher than 5 g/m³ and the relative humidity is lower than 100% RH.

3. The ink jet recording apparatus according to claim 1, wherein the humidifying portion is provided on a recording surface side of the recording medium so as not to come in contact with the recording medium.

4. The ink jet recording apparatus according to claim 1, wherein the humidifying portion is provided on an upstream side in a feeding direction of the recording medium from a position in which the nozzle is to be provided.

5. The ink jet recording apparatus according to claim 1, further comprising a nozzle vicinity air temperature detecting portion for detecting a temperature of air in the vicinity of the nozzle; and
a nozzle surface temperature detecting portion for detecting a temperature of a nozzle surface,
the humidifying portion driving control portion controlling the humidifying portion such that a temperature of the air in the vicinity of the nozzle is equal to or lower than the temperature of the nozzle surface.

6. The ink jet recording apparatus according to claim 1, further comprising a flushing ejection control portion for carrying out a flushing ejection for a liquid passage and a nozzle opening portion in the recording head.

7. The ink jet recording apparatus according to claim 6, wherein the flushing ejection control portion executes the flushing ejection at a time of 100 sec or less.

8. The ink jet recording apparatus according to claim 6, wherein the flushing ejection control portion carries out a flushing ejection in a continuous ejection of 1 to 1000 shots.

9. The ink jet recording apparatus according to claim 6, wherein the flushing ejection control portion carries out the flushing ejection at an equal ejection driving frequency to that in a recording operation.

10. The ink jet recording apparatus according to claim 6, wherein the flushing ejection control portion carries out the flushing ejection over the recording medium while maintaining a recording operation.

11. The ink jet recording apparatus according to claim 6, further comprising a liquid ejecting portion provided in a place other than a place in which the recording medium is disposed and serving to receive a droplet ejected through flushing of the liquid passage and the nozzle opening portion in the recording head,
the flushing ejection control portion carrying out the flushing ejection when the recording head is positioned on the liquid ejecting portion.

12. The ink jet recording apparatus according to claim 1, wherein the liquid contains water and a humectant.

13. The ink jet recording apparatus according to claim 12, wherein a viscosity of the liquid is set to be equal to or higher than 4 mPa·s.

14. The ink jet recording apparatus according to claim 2, wherein the humidifying portion is provided on a recording surface side of the recording medium so as not to come in contact with the recording medium.

15. The ink jet recording apparatus according to claim 2, wherein the humidifying portion is provided on an upstream side in a feeding direction of the recording medium from a position in which the nozzle is to be provided.

16. The ink jet recording apparatus according to claim 2, further comprising a nozzle vicinity air temperature detecting portion for detecting a temperature of air in the vicinity of the nozzle; and
a nozzle surface temperature detecting portion for detecting a temperature of a nozzle surface,
the humidifying portion driving control portion controlling the humidifying portion such that a temperature of the air in the vicinity of the nozzle is equal to or lower than the temperature of the nozzle surface.

17. The ink jet recording apparatus according to claim 2, further comprising a flushing ejection control portion for carrying out a flushing ejection for a liquid passage and a nozzle opening portion in the recording head.

18. The ink jet recording apparatus according to claim 17, wherein the flushing ejection control portion executes the flushing ejection at a time of 100 sec or less.

19. The ink jet recording apparatus according to claim 17, wherein the flushing ejection control portion carries out a flushing ejection in a continuous ejection of 1 to 1000 shots.

20. The ink jet recording apparatus according to claim 17, wherein the flushing ejection control portion carries out the flushing ejection at an equal ejection driving frequency to that in a recording operation.

21. The ink jet recording apparatus according to claim 17, wherein the flushing ejection control portion carries out the flushing ejection over the recording medium while maintaining a recording operation.

22. The ink jet recording apparatus according to claim 17, further comprising a liquid ejecting portion provided in a place other than a place in which the recording medium is disposed and serving to receive a droplet ejected through flushing of the liquid passage and the nozzle opening portion in the recording head,
the flushing ejection control portion carrying out the flushing ejection when the recording head is positioned on the liquid ejecting portion.

23. The ink jet recording apparatus according to claim 2, wherein the liquid contains water and a humectant.

24. The ink jet recording apparatus according to claim 23, wherein a viscosity of the liquid is set to be equal to or higher than 4 mPa·s.
